(19) United States
(12) Patent Application Publication
(10) Pub. No.: US 2026/0334352 A1
(43) Pub. Date: Oct. 29, 2026

(54) SYSTEM AND METHODS FOR SEED, SEEDLING, AND OTHER ORGANISM DELIVERY TO ABOVE AND BELOW WATER SURFACE IN AND AROUND AQUEOUS ENVIRONMENTS AND FOR AQUACULTURE

(71) Applicant: Beta Earth, LLC, Reno, NV (US)

(72) Inventors: Lauren Edwards Fletcher, Reno, NV (US); Irina Fedorenko, Oxford (GB)

(21) Appl. No.: 19/661,290

(22) Filed: Apr. 28, 2026

Related U.S. Application Data
(60) Provisional application No. 63/797,041, filed on Apr. 29, 2025.

(51) Int. Cl. A01C 7/18; A01C 7/20

(52) U.S. Cl. CPC A01C 7/18; A01C 7/208

(57) ABSTRACT

A system for distributing a plurality of organisms in an aquatic ecosystem is described. In one embodiment, the system includes a plurality of organisms incorporated into a plurality of organism delivery structures, wherein each of the plurality of organisms is a non-animal biota. Furthermore, the system can include a mobile platform, configured to be guided by remote control or to autonomously move to distribute the plurality of organisms using the plurality of organism delivery structures in a distribution pattern. In addition, the system can include a storage compartment, coupled to the mobile platform, that holds the plurality of organism delivery structures. The system can further include a feeder system, coupled to the storage compartment, that ejects each of the plurality of organism delivery structures according to the distribution pattern, wherein each of the plurality of organisms is distributed at a desired location in the aquatic ecosystem.

This application claims the benefit of U.S. Provisional Patent Application No. 63/797,041, filed on Apr. 29, 2025, which application is incorporated herein by reference.

### FIELD OF THE INVENTION

This invention relates generally to agriculture and more particularly to delivering seed, seedlings, and/or other organisms to above, on, and/or below a water surface in and around an aquatic ecosystem and for aquiculture.

### BACKGROUND OF THE INVENTION

Aquatic ecosystems are a crucial part of water-based environments and provide numerous ecological benefits such as improving water quality, sequestering carbon, and providing habitats for marine life. Their role is both environmental and economic; however, these ecosystems are under threat. For example, more than 30% of global seagrass meadows have been lost over the last 100 years.

Traditional methods of restoring these aquatic ecosystems are typically accomplished by labor-intensive methods. For instance, seagrass restoration includes scuba diving and is limited in scope and can cost as much as $400 k/Ha, leaving governments few options.

Positive environmental impacts of restoration of these aquatic ecosystems include: 1) Improved local ecosystems and hydrological and soil nutrient cycles. 2) Rebuilding vital habitats for animals, birds, and aquatic species and increasing biodiversity. 3) Protection from extreme weather events (tsunamis & flooding). 4) Provide food, shelter, raw materials, and income generation opportunities for local communities. 5) Increase the natural carbon sink.

### SUMMARY OF THE INVENTION

Some embodiments disclosed herein are directed to a system for distributing a plurality of organisms in an aquatic ecosystem.

A system for distributing a plurality of organisms in an aquatic ecosystem is described. In one embodiment, the system includes a plurality of organisms incorporated into a plurality of organism delivery structures, wherein each of the plurality of organisms is a non-animal biota. Furthermore, the system can include a mobile platform, configured to be guided by remote control or to autonomously move to distribute the plurality of organisms using the plurality of organism delivery structures in a distribution pattern. In addition, the system can include a storage compartment, coupled to the mobile platform, that holds the plurality of organism delivery structures. The system can further include a feeder system, coupled to the storage compartment, that ejects each of the plurality of organism delivery structures according to the distribution pattern, wherein each of the plurality of organisms is distributed at a desired location in the aquatic ecosystem.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those having ordinary skill in the art upon reading the following detailed description, and by referring to the accompanying drawings. It should be appreciated that this disclosure may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

The present invention is illustrated by way of example and not limitation in the figures of the accompanying drawings in which like references indicate similar elements.

FIG. 1 is an illustration of direct seeding to deliver treated and untreated seeds to a target destination, in accordance with embodiments of the present invention.

FIG. 2 is an illustration of an example of a spherical Seedball and its components, in accordance with embodiments of the present invention.

FIG. 3 is an illustration of an example of a Seed Puck and its components, in accordance with embodiments of the present invention.

FIG. 4 is an illustration of an example of a Seedling Cone, its components, and various design features, in accordance with embodiments of the present invention.

FIG. 5 is an illustration of an example of different Drop Bags, in accordance with embodiments of the present invention.

FIG. 6 is an illustration of an example of a Deployable Mat and its components in a flat deployed configuration and rolled configuration, in accordance with embodiments of the present invention.

FIG. 7 is an Illustration of an example of different Surface Mobile Platforms, in accordance with embodiments of the present invention.

FIG. 8 is an illustration of an example of a Submersible Mobile Platform, in accordance with embodiments of the present invention.

FIG. 9 is an illustration of an example of a Floor Robotic Mobile Platform, in accordance with embodiments of the present invention.

FIG. 10 is an illustration of an example of the Direct Seeding Subsystem Payload and use cases with the Aerial and Surface Mobile Platforms, in accordance with embodiments of the present invention.

FIG. 11 is an illustration of an example of the Seedball Subsystem Payload and its components, in accordance with embodiments of the present invention.

FIG. 12 is an illustration of an example of different seedball separation mechanisms for the Seedball Subsystem Payload, in accordance with embodiments of the present invention.

FIG. 13 is an illustration of an example of different seedball release mechanisms that allow the seedballs to be dropped by gravity or to have an induced velocity applied to the seedball to propel it away from the Seedball Subsystem Payload and Mobile Platform, in accordance with embodiments of the present invention.

FIG. 14 is an illustration of an example of Seedball Subsystem Payloads when mounted to Aerial and Floor Robotic Mobile Platforms, in accordance with embodiments of the present invention.

FIG. 15 is an illustration of an example of the Seed Puck Subsystem Payload and its components, in accordance with embodiments of the present invention.

FIG. 16 is an illustration of an example of different seed puck release mechanisms that allow the seed pucks to be dropped by gravity or to have an induced velocity applied to the seed puck to propel it away from the Seed Puck Subsystem Payload and Mobile Platform, in accordance with embodiments of the present invention.

FIG. 17 is an illustration of an example of Seed Puck Subsystem Payloads when mounted to Aerial, Submersible, and Floor Robotic Mobile Platforms, in accordance with embodiments of the present invention.

FIG. 18 is an illustration of an example of the Seedling Cone Subsystem Payload and its components with a cylindrical tube and tray-based storage and dispensing system, in accordance with embodiments of the present invention.

FIG. 19 is an illustration of an example of the Seedling Cone Subsystem Payload and its components with a magazine-based storage and dispensing system, in accordance with embodiments of the present invention.

FIG. 20 is an illustration of an example of the Drop Bag Subsystem Payload and its components with a cylindrical tube and tray-based storage and dispensing system, in accordance with embodiments of the present invention.

FIG. 21 is an illustration of an example of the Drop Bag Subsystem Payload and its components with a magazine-based storage and dispensing system, in accordance with embodiments of the present invention.

FIG. 22 is an illustration of an example of the Deployable Mat Subsystem Payload and its components with a flat, extended Deployable Mat, in accordance with embodiments of the present invention.

FIG. 23 is an illustration of an example of the Deployable Mat Subsystem Payload and its components with a rolled Deployable Mat, in accordance with embodiments of the present invention.

FIG. 24 is an illustration of an example of the Surface Docking and the Take-off and Landing Platforms for the retrieval of the Aerial, Submersible, and Floor Robotic Mobile Platforms and their components, in accordance with embodiments of the present invention.

FIG. 25 is an illustration of control circuitry, according to some implementations.

### DETAILED DESCRIPTION

A system for distributing organisms above, on, and below the surface of the water is described. In at least one embodiment, the system can operate in aquatic ecosystem environments that include, but are not limited to, oceans, seas, lakes, rivers, streams, wetlands, swamps, peatlands, coastal, tidal ways, everglades, mangroves, and/or other types of aquatic ecosystems.

In at least one embodiment, the system can comprise one or more structures to protect and provide one or more nutrients to the organisms (defined and referred to here as Organism Delivery Structures), one or more mobile platforms to transport the organisms to the target destination (defined and referred to here as Mobile Platforms), and one or more payloads on the mobile platforms to store and distribute the organism delivery structures (defined and referred to here as Subsystem Payloads). In further embodiments, the system can comprise one or more additional supporting systems including, but not limited to, Guidance Systems, Mapping Systems, Surface Docking and Take-off and Landing Platforms, Electromechanical Robotic Arm, Data, Data Analytics, and AI algorithms.

### Organism Delivery Structures:

The core objective of the invention is to distribute organisms in an aquatic ecosystem. In some embodiments, organisms can be distributed as a treated or untreated seed with Direct Seeding. In some embodiments, organisms can be distributed as a seed or seedling within an Organism Delivery Structure that protects the organism and can provide additional nutrients and anti-predation additives. In some embodiments, the organisms can be prepared in a number of forms including as treated and untreated seeds and within an Organism Delivery Structure in the form of seedballs, seed pucks, seedling cones, drop bags, and deployable mats. In this embodiment, each of the organism delivery structures can include one or more of seeds, seedlings, other organisms like bacteria and fungi, soil or sediment, nutrients, activated carbon or biochar, and/or anti-predation additives, as appropriate. In some embodiments, a use of an Organism Delivery Structure is that the Organism Delivery Structure(s) can be manufactured to have a net-negative buoyancy to allow Organism Delivery Structure(s) to sink to the soil or sediment in an aquatic ecosystem, or somewhere below the water surface but above the aquatic floor. In at least one embodiment, the subsystem payloads and mobile platforms can be designed to accommodate Direct Seeding (discussed below) and each of the forms of the Organism Delivery Structures. In some embodiments, the organism delivery structures can include an RFID chip or another type of electronic identifier for in situ detection before and after placement.

Direct Seeding—In some embodiments, seeds can be distributed directly in the target destination by Direct Seeding. In some embodiments, seeds can be untreated or treated by whatever method and scaring protocols that are required and specific to that seed species and environmental conditions of the target destination to ensure the seeds are ready to germinate once in situ at the target destination. In some embodiments the seeds can be loaded into the central storage of the direct seeding subsystem payload and distributed according to the description of the Direct Seeding Subsystem Payload and the mapping system generated distribution map.

Seedball Organism Delivery Structure—While seedballs have been previously used extensively in land-based ecosystem restoration and tree planting, seedballs have not been considered previously for water based ecosystem restoration because it was believed that they will dissolve and break-apart in an aqueous environment and/or not sink because of the included seeds and compost creating a positive buoyancy. Seedballs, however, they actually have key advantages with a net-negative buoyancy design in restoration of subsurface and aquatic ecosystems. In some embodiments, seedball Organism Delivery Structures can be made of dense soil and clays for the mechanical structure and, therefore, can withstand the aqueous environment long enough to deposit the seeds and allow for germination and establishment. In some embodiments, the content of soil and clays for the mechanical structure in the manufacturing of Seedball Organism Delivery Structures can be varied depending on the content of seeds and compost type nutrients to result in a net-negative buoyancy such that they will be denser than water and will sink to the floor of the target destination. In some embodiments, the Seedball Organism Delivery Structure can be spherical (or approximately spherical) in form. In some embodiments, the Seedball Organism Delivery Structure can be manufactured with a mix of clay, compost, an activated carbon source or biochar, nutrients, micro-nutrients, seeds, and/or other organisms (such as, but not limited to, bacteria, fungi, and archaea). Furthermore, the Seedball Organism delivery Structures can include an anti-predation material necessary to prevent local species from eating or predating the seeds or other organisms. In some embodiments, the Seedball Organism Delivery Structures can be loaded into the central storage of the Seedball Subsystem Payload and distributed according to the description of the payload and the mapping system generated distribution map.

Seed Puck Organism Delivery Structure—While Seed pucks have been previously used in land-based ecosystem restoration and tree planting, Seed pucks have not been considered previously for water based ecosystem restoration because it was believed that they will dissolve and break-apart in an aqueous environment and/or not sink because of the included seeds and compost creating a positive buoyancy. Seed pucks, however, can have a key advantage with a net negative buoyancy in a restoration of an aquatic ecosystems. In some embodiments, Seed Pucks Organism Delivery Structures can be made of dense soil and clays for the mechanical structure and, therefore, can withstand the aqueous environment long enough to deposit the seeds and allow for germination and establishment. In some embodiments the Seed Puck Organism Delivery Structure can be a flat, cylinder “puck like” structure. In some embodiments, the Seed Puck Delivery Structure can be manufactured with a mix of clay, compost, an activated carbon source or biochar, nutrients, micro-nutrients, seeds, and/or other organisms (such as, but not limited to, bacteria, fungi, and archaea). Furthermore, the Seed Pucks Organism Delivery Structures can include an anti-predation materials necessary to prevent local species from eating and predating the seeds or other organisms. In some embodiments, content of soil and clays for the mechanical structure in manufacturing of the Seed Puck Delivery Structure can be varied depending on the content of all other components to result in a net-negative buoyancy such that the Seed Puck Organism Delivery Structure will be denser than water and will sink to the floor of the target destination. In some embodiments, the Seed Puck Organism Delivery Structures can be loaded into the tubes of the Seed Puck Subsystem Payload and distributed according to the description of the payload and the mapping system generated distribution map.

Seedling Cone Organism Delivery Structure—In some embodiments, Seedling Cone Organism Delivery Structures can be conical-shaped (or approximately conical). In some embodiments, Seedling Cone Organism Delivery Structures can be manufactured out of a biodegradable material. In some embodiments, the interior of the cone of the can be filled with a mix of clay, compost, an activated carbon source or biochar, nutrients, micro-nutrients, seeds, seedlings, and/or other organisms (such as, but not limited to, bacteria, fungi, and archaea). Furthermore, the Seedling Cone Organism Delivery Structure can include an anti-predation material used to prevent local species from eating the seeds, seedlings, or other organisms. In some embodiments, the content of soil and clays in the interior of the Seedling Cone Organism Delivery Structure can be varied depending on the content of all other components to result in a net-negative buoyancy such that the Seedling Cone Organism Delivery Structure can be denser than water and can sink to the floor of the target destination. In some embodiments, the seeds can be germinated and grown into seedlings within the Seedling Cone Organism Delivery Structure prior to distribution to the target destination. In some embodiments, the seedlings can be grown separately and then can be inserted into the Seedling Cone Organism Delivery Structure just prior to distribution to the target destination. In some embodiments, other organisms such as bacteria and fungi can be included to increase the growth and productivity of the seedlings. In some embodiments, nutrients and micronutrients can be included to increase the growth and productivity of the seedlings. In some embodiments, anti-predation materials can be added to prevent local species from eating the seeds or seedlings. In some embodiments, the Seedling Cone Organism Delivery Structure can be weighted to ensure that the pointed end of the Seedling Cone Organism Delivery Structure is facing downwards and that the roots of the seedlings are inserted into the floor sediment. In some embodiments, the Seedling Cone Delivery Structure can have a hydro-dynamic feature on the outside to induce a spin stabilization as it drops from the water surface to the floor of the aquatic ecosystem. The spin stabilization can reduce the water resistance and further ensure that the pointed end of the cone is facing downwards and that the downward velocity provides enough force to seat the end of the cone into the floor sediment. In some embodiments, the seedling cone organism delivery structure can have openings along the sides near the bottom to allow roots to grow into the surrounding sediment or soil.

Drop Bag Organism Delivery Structure—In some embodiments, Drop Bag Organism Delivery Structures can be flexible, non-rigid, or semi-rigid containers and manufactured out of a biodegradable material. In some embodiments, Drop Bag Organism Delivery Structures can be in the form of an open top bag. In some embodiments Drop Bag Organism Delivery Structures can be a closed “bean-bag” like structure. In some embodiments, the Drop Bag Organism Delivery Structure can have a strap or a ring for mounting to the Drop Bag Subsystem Payload. In some embodiments, the Drop Bag Organism Delivery Structure can be filled with soil and/or sediment, biochar or activated carbon/charcoal, nutrients, anti-predation additives, seeds, seedlings, fungi, and/or other organisms (such as, but not limited to, bacteria, fungi, archaea, etc.), and any anti-predation materials necessary to prevent local species from eating the seeds, seedlings, or other organisms. In some embodiments, content of soil and clays in the interior of the Seedling Cone Organism Delivery Structure can be varied depending on the content of all other components to result in a net-negative buoyancy such that they can be denser than water and can sink to the floor of the target destination. In some embodiments, the material and texture of the Drop Bag Organism Delivery Structure can be a mesh, weave, extruded, or any other type of material formation that will allow the containment of the other components while allowing the roots of the germinated seed or seedling to pass through the wall of the bag and establish within the floor of the water-based ecosystem. In some embodiments, seeds can be placed within the soil/sediment within the Drop Bag Organism Delivery Structure and can be germinated and grown into seedlings prior to deployment. In some embodiments, germinated seedlings can be transferred to the Drop Bag Organism Delivery Structure prior to deployment. In some embodiments, other organisms such as bacteria and fungi can be included to increase the growth and productivity of the seeds or seedlings. In some embodiments, nutrients and micronutrients can be included. In some embodiments, anti-predation materials can be added to prevent local species from eating and predating the seeds or other organisms. In some embodiments, the Drop Bag Organism Delivery Structure can be weighted to ensure that the drop bag falls bottom-side down when released and distributed and can sink to the floor within an aquatic ecosystem with the bottom-side down.

Deployable Mat Organism Delivery Structure—In some embodiments, Deployable Mat Organism Delivery Structures can be a meshed structure with open spaces that lie flat on a target destination surface, above and below the surface of the water. In some embodiments, Deployable Mat Organism Delivery Structures can be manufactured with a biodegradable material. In some embodiments, the spaces of the Deployable Mat Organism Delivery Structures can be filled with soil or sediment, as appropriate for the target destination. In some embodiments, the content of soil and clays in the interior of the Deployable Mat Organism Delivery Structure can be varied depending on the content of all other components to result in a net-negative buoyancy such that the Deployable Mat Organism Delivery Structure can be denser than water and can sink to the floor of the target destination. In some embodiments, seeds can be placed in the soil/sediment within the spaces and can be germinated and grown into seedlings prior to deployment, or the structure can be moved to the target destination prior to germination and growth. In some embodiments, other organisms such as bacteria and fungi can be included to increase the growth and productivity of the seedlings. In some embodiments, nutrients and micronutrients can be included. In some embodiments, anti-predation materials can be added to prevent local species from eating the seeds or other organisms. In some embodiments, the Deployable Mat Organism Delivery Structure can be deployed in an extended, flat configuration. In some embodiments, the Deployable Mat Organism Delivery Structure can be rolled for transportation to the target destination. In some embodiments, the rolled configuration of the Deployable Mat Organism Delivery Structure can have a spring-loaded trigger that can release and extend the mat when it reaches the target destination. In some embodiments, the rolled configuration of the Deployable Mat Organism Delivery Structure can have one end weighted with the trigger mechanism so that it can sink that end first. In some embodiments, one or more Deployable Mat Organism Delivery Structure can be carried and distributed by the aerial and surface mobile platforms.

### Mobile Platforms:

In one embodiment, the Mobile Platform(s) can be designed to transport the organisms to the target destination. In one embodiment, the system can comprise one or more Mobile Platforms for the distribution of seed, seedlings, and other organisms. In some embodiments, the Mobile Platforms can include one or more of an Aerial, Surface, Submersible, or Floor Robotic Mobile Platform.

In some embodiments, the Mobile Platforms can have elements that are similar across each of the types of mobile platforms (e.g., subsystems for propulsion, communications, storage, delivery, control, power, guidance), though some have features that can be specific to their specific environment (e.g. aerial propellers for the Aerial Mobile Platforms vs. water propellers for Surface Mobile Platforms). In one embodiment, a mobile platform can be defined as a manned, remotely controlled, or autonomous vehicle that enables the transport of organisms to the target destination.

Mobile Platform 1: Aerial. In at least one embodiment, the Aerial Mobile Platform can be an aircraft system that allows the aerial mobile platform to travel above the land or water surface. In some embodiments, the aerial mobile platform can be a manned aerial vehicle (e.g., aircraft or helicopter), an Unmanned Aerial Vehicle (UAV), or a lighter than air system (e.g., balloon, blimp, or any other type of system) which can be tethered to another mobile platform or can be independently powered. In some embodiments, the aerial mobile platform can be a fixed wing, rotor, or multi-rotor aircraft. In some embodiments, the aerial mobile platform can be a Remotely Operated Vehicle (ROV). In some embodiments, the aerial mobile platform can be an automated, aerial mobile platform and can be autonomous system. In some embodiments, the aerial mobile platform can be a manned system. In at least one embodiment, an aerial mobile platform can carry a subsystem payload for distribution of seeds by direct seeding or a subsystem payload for distribution of organism delivery structures (e.g., seedballs, seedling cones, seed pucks, drop bags, deployable mats, any other organism delivery structure, and/or a combination therein) for restoration of the aquatic ecosystems as previously described. In some embodiments, the aerial mobile platform can have on-board power, electronic control systems, and guidance systems to operate the payload and distribute the organisms to the preselected target destination.

Mobile Platform 2: Surface. In at least one embodiment, the Surface Mobile Platform can have positive buoyancy to remain on the water surface. In some embodiments, the Surface Mobile Platform can be an ROV. In some embodiments, the surface mobile platform can be an automated, autonomous system. In some embodiments, the surface mobile platform can be a manned system. In at least one embodiment, a surface mobile platform can carry a subsystem payload for distribution of seeds by direct seeding or a subsystem payload for distribution of organism delivery structures (e.g., seedballs, seedling cones, seed pucks, drop bags, deployable mats, and any other organism delivery structure) for restoration of the aquatic ecosystems as previously described. In some embodiments, the surface mobile platform can have on-board power, electronic control systems, and guidance systems to operate the payload and distribute the organisms to the preselected target destination.

Mobile Platform 3: Submersible. In at least one embodiment, the Submersible Mobile Platform can have buoyancy control to allow the system to operate at the surface or subsurface down to the floor of the aquatic ecosystem being restored. In some embodiments, the submersible mobile platform can be an ROV. In some embodiments, the submersible mobile platform can be an automated, autonomous system. In some embodiments, the submersible mobile platform can be tethered to a surface mobile or stationary system. In at least one embodiment, the submersible mobile platform can carry a subsystem payload for distribution of organism delivery structures (e.g., seedballs, seedling cones, seed pucks, drop bags, and any other organism delivery structure) for restoration of the aquatic ecosystems as previously described. In some embodiments, the submersible mobile platform subsystem payload can have an air-pressurized bell chamber or compartment to keep the organism delivery structures dry before they are distributed in their specific target destination. In some embodiments, the submersible mobile platform can have an electromechanical robotic arm to place any forms of the organism delivery structures onto or into the soil or sediment of the specific preselected target destination. In some embodiments, the submersible mobile platform can have on-board power, electronic control systems, and guidance systems to operate the payload and distribute the organisms to the preselected target destination.

Mobile Platform 4: Floor Robotic. In at least one embodiment, the Floor Robotic Mobile Platform can move along the floor of the target aquatic ecosystem being restored. In some embodiments, the floor robotic mobile platform can be an ROV. In some embodiments, the floor robotic mobile platform can be an automated, autonomous system. In some embodiments, the floor robotic mobile platform can be tethered to a surface mobile platform, a docking platform, and/or to a submersible mobile platform. In some embodiments, the floor robotic mobile platform can carry a subsystem payload for distribution of organism delivery structures (e.g., seedballs, seedling cones, seed pucks, drop bags, and any other organism delivery structure) for restoration of the ecosystems as previously described. In some embodiments, the floor robotic mobile platform subsystem payload can have an air-pressurized bell chamber or compartment to keep the organism delivery structures dry before they are distributed in their specific preselected target destination. In some embodiments the floor robotic mobile platform can have an electromechanical robotic arm to place any forms of the organism delivery structures onto or into the soil or sediment of the specific preselected target destination. In some embodiments, the electromechanical robotic arm can have a piston system to push the organism into the sediments on the floor of the aquatic ecosystem being restored. In some embodiments, the piston system can be attached to the electromechanical robotic arm or to the mobile platform. In some embodiments, the floor robotic mobile platform can have on-board power, electronic control systems, and guidance systems to operate the payload and distribute the organisms to the preselected target destination.

### Restoration Subsystem Payloads:

In some embodiments, the Restoration Subsystem Payloads can be where the seeds and organism delivery structures can be stored on the mobile platforms.

In some embodiments, the mobile platforms can be designed to be a system to provide mobility, guidance, power, and data communications and other supporting systems to the Subsystem Payloads which can be designed specifically for each of the organism delivery structures and the specific target environment. In some embodiments, Subsystem Payloads for distribution of seeds or organism delivery structures will have similar features across the mobile platforms, but with differences specific to each of them. For instance, the central storage compartment on the surface mobile platform can be significantly larger than the central storage compartment on the aerial mobile platform, while it may need to be a pressurized container to keep the organisms or organism delivery structures dry on the submersible and floor robotic mobile platforms. A number of common features can be included on the Subsystem Payloads with a configuration specific to each subsystem payload and mobile platform. An applicability matrix of how the features can be used in which mobile platform and subsystem payload with each organism delivery structure is provided in the following Applicability Matrix Table.

In some embodiments, the Subsystem Payloads can have internal subsystems to release the Organism Delivery Structures to fall by gravity to the target destination surface or into an electromechanical actuator to induce a velocity to propel the Organism Delivery Structure away from the Subsystem Payload and Mobile Platform. In some embodiments, the methods of inducing a velocity to an Organism Delivery Structure can include, but are not limited to, dropping, launching, firing with a pressurized or compressed gas system, or released with any type of mechanism or latch relying on a gravity drop or other mechanism to induce a velocity.

Direct Seeding Subsystem Payload—In some embodiments, the Direct Seeding Subsystem Payload can have a central storage container to hold treated or untreated seeds. In some embodiments, once the mobile platform reaches the target destination, the seeds can be released and distributed out the bottom which can then fall to the surface of the target destination and environment. In some embodiments, the distribution pattern can follow a distribution map generated by the mapping system. In some embodiments, the Direct Seeding Subsystem Payload system can be mounted to the aerial and surface mobile platforms, with modifications and features specific to each mobile platform.

Seedball Subsystem Payload—In some embodiments, the Seedball Subsystem Payload can have a central storage container to hold the prepared seedballs. In some embodiments, once the mobile platform has reached the target destination, the seedballs can be released and distributed by a number of mechanisms, including but not limited to, gravity dropping, launching, and/or with a pressurized gas firing system. In some embodiments, the seedball subsystem payload can be mounted to the aerial, surface, submersible, and floor robotic mobile platforms, with modifications and features specific to each mobile platform. In some embodiments, an electromechanical robotic arm can be used for specific placement on the submersible and floor robotic platforms. In some embodiments, a pressurized bell chamber or container to store the seedballs dry until they can be used with the submersible and floor robotic platforms. In some embodiments, a pusher/plunger can be added to the electromechanical robotic arm to push the seedball into the floor sediment. In some embodiments a pusher/plunger can be mounted directly to the submersible or floor robotic platform to push the seedball into the floor sediment.

Seed Puck Subsystem Payload—In some embodiments, the Seed Puck Subsystem Payload can have a number of tubes which contain and store stacked seed pucks. In some embodiments, the tubes can be organized in an X by Y configuration. In some embodiments, the total number of tubes can be dependent upon the physical geometry limitations of the specific mobile platform. In some embodiments, once the mobile platform has reached the destination, the seed pucks can be released and distributed by a number of mechanisms, including but not limited to, gravity dropping and launching, and/or with a pressurized gas firing system. In some embodiments, the seed puck subsystem payload system can be mounted to the aerial, surface, submersible, and floor robotic mobile platforms, with modifications and features specific to each mobile platform. In some embodiments, an electromechanical robotic arm can be used for specific placement on the submersible and floor robotic platforms. In some embodiments, a pressurized tube to store the seed pucks dry can be used with the submersible and floor robotic platforms. In some embodiments, a pusher/plunger can be added to the electromechanical robotic arm to push the seed puck into the floor sediment. In some embodiments, a pusher/plunger can be mounted directly to the submersible and floor robotic platform to push the seed puck into the floor sediment.

Seedling Cone subsystem payload—In some embodiments, the Seedling Cone Subsystem Payload can distribute seedlings previously prepared and grown in or transferred to a weighted cone structure. In some embodiments, the seedling cones can be loaded into a tube, tray, or magazine feeder and each seedling cone can be individually released and distributed at the designated target destination. In some embodiments, the seedling cone subsystem payload can be mounted to the aerial, surface, submersible, and floor robotic mobile platforms, with modifications and features specific to each mobile platform. In some embodiments, an electromechanical robotic arm mounted to the submersible or floor robotic mobile platforms can be used to place and push the cones into the floor sediment.

Drop Bag subsystem payload—In some embodiments, the Drop Bag Subsystem Payload can distribute seeds and seedlings previously prepared and grown in or transferred to a drop bag. In some embodiments, the drop bag subsystem payload can have a magazine with an electronically activated latch or hook to mount a drop bag with a ring or strap. In some embodiments, a conveyer belt can be used to drop the bag over the target destination. In some embodiments, the Drop Bag Subsystem Payload can be mounted to the aerial, surface, and submersible mobile platforms, with modifications and features specific to each platform. In some embodiments, an electromechanical robotic arm mounted to the submersible or floor robotic mobile platforms can be used to place the drop bag onto the floor sediment.

Deployable Mat Subsystem Payload—In some embodiments, the Deployable Mat Subsystem Payload can distribute seeds and seedlings prepared and grown in a meshed structure with open space that lie flat on a target surface. In some embodiments, the deployable mat subsystem payload has a support structure to contain one or more of the deployable mat organism delivery structures in an extended, flat configuration. In some embodiments, the deployable mat subsystem payload has a support structure to contain one or more of the deployable mat organism delivery structures in a rolled configuration. In some embodiments, the deployable mat subsystem payload support structure can have an electronically controlled latch to allow the deployable mat to be released individually and distributed at the designated target destination. In some embodiments, the deployable mat subsystem payload can be mounted to the aerial and surface mobile platforms, with modifications and features specific to each mobile platform.

### Guidance System:

In one embodiment, a Guidance System can be a stand-alone system that can have one or more sensors to help in the guidance of the various mobile platforms to their preselected target destination. In some embodiments, the Mobile Platforms can integrate data from the Guidance System and/or additional on-board and external sensor data sets to provide a real-time correction to the generated pathway the mobile platforms follows to the target destination. In some embodiments, the Mobile Platform can integrate data from the Guidance System and additional on-board and external sensor data sets to provide a real-time correction to the generated distribution map for the release and distribution pattern of seeds or organism delivery structures at the target destination.

In some embodiments, the mobile platforms can be networked to a guidance system component. In some embodiments, the guidance system component can be aerial, surface, and/or subsurface based. In some embodiments, the guidance systems can have Real-Time Kinematic Global Positioning System (RTK GPS) correction sensors or other electronic geo-positioning sensors. In some embodiments, the Guidance System can have, but are not limited to, visual or other electromagnetic sensors, depth finders, wind speed and direction, water flow rates and direction, tidal, wave, wave height sensors, and/or a combination therein. In some embodiments, the Guidance system can process the sensor data and any additional third-party data to generate a correction signal. In some embodiments, the guidance system can have a communications subsystem to transmit the correction signal to the mobile platform guidance subsystem. In some embodiments, the guidance system can be an aerial system. In some embodiments, the guidance system can be a water surface vehicle with a variable buoyancy.

Guidance System 1: Aerial. In some embodiments, the Guidance System can be an aerial system. In some embodiments, the aerial-based guidance system can be a lighter than air system (balloon, blimp, or any other type of system) which can be tethered to another mobile platform or docking platform or can be independently powered. In some embodiments, the aerial guidance system can be a fixed wing, rotor, or multi-rotor aircraft. In some embodiments, the aerial guidance system can be an ROV. In some embodiments, the aerial guidance system can be an automated, autonomous system. In some embodiments, the aerial guidance system can be a manned system. In some embodiments, the aerial guidance system can include GPS and/or other geo-positioning sensors to provide a correction guidance signal to the mobile platforms to guide the mobile platform to the correct target destination.

Guidance System 2: Water-Based System. In some embodiments, the guidance system can be a water-based system. In some embodiments, the water-based guidance system can be a boat, closed submersible, or other water structure. In some embodiments, the water-based guidance system can vary the buoyancy to be positive and remain on the water surface or to negative buoyancy to drop below the water surface to the floor of the target destination. In some embodiments, the water-based guidance system can be tethered to a surface mobile platform or a docking platform and can be independently powered. In some embodiments, the water-based guidance system can be an ROV. In some embodiments, the water-based guidance system can be an automated, autonomous system. In some embodiments, the water-based guidance system can be a manned system. In some embodiments, the water-based aerial guidance platform can include GPS and/or other geo-positioning sensors to provide a correction guidance signal to mobile platforms to guide the mobile platform to the correct target destination.

### Mapping System:

In one embodiment, an integrated mapping system can collect data from a variety of one or more sensors mounted to the mobile platforms or to another type of mapping platforms. In some embodiments, an algorithm can integrate the data from these systems and other third-party data sets to generate a planting and navigation map through the subsurface and nearshore environments. In some embodiments, seeds or the organism delivery structures can be distributed following this generated planting pattern. In some embodiments, the navigation map can provide a pathway for the mobile platforms internal guidance subsystems to follow to reach specific target destinations.

Mapping System 1: Aerial. In some embodiments, the Mapping System can be an aerial system. In some embodiments, the aerial-based mapping system can be a UAV or a lighter than air system (balloon, blimp, or any other type of system) which can be tethered to another mobile platform or the take-off and landing platform or can be independently powered. In some embodiments, the aerial mapping system can be a fixed wing, rotor, or multi-rotor aircraft. In some embodiments, the aerial mapping system can be an ROV. In some embodiments, the aerial mapping system can be an automated, autonomous system. In some embodiments, the aerial mapping system can be a manned system. In some embodiments, the aerial mapping system can include a number of one or more sensors to collect and record data to map above and below water surface features. In some embodiments, sensors that can be included, but are not limited to, are visual, infrared, near-infrared, Light Detection and Ranging (LiDAR), Radar, temperature, depth, humidity, salinity, Total Dissolved Solids (TDS), and/or other types of sensors related to a mapping function. In some embodiments, the features recorded can include, but are not limited to, geolocation, topology, vegetative coverage (below & above water surface), biodiversity, invasive species, soil and sediment types, water flow rates and direction, salinity, oxygen content, presence of toxic compounds, and/or other types of features to be recorded.

Mapping System 2: Surface System. In some embodiments, the Mapping System can be a surface-based system. In some embodiments, the surface mapping system can be a boat or other water vehicle or structure that maintains a positive buoyancy and remains on the water surface. In some embodiments, the surface mapping system can be tethered to a surface mobile platform or a docking platform and can be independently powered. In some embodiments, the surface mapping platform can be an ROV. In some embodiments, the surface mapping system can be an automated, autonomous system. In some embodiments, the surface mapping system can be a manned system. In some embodiments, the surface mapping system can have on-board power and control and guidance systems to operate the sensors. In some embodiments, the surface mapping system can include a number of sensors to collect and record data to map above and below water surface features. In some embodiments, sensors that can be included, but are not limited to, are visual, infrared, near-infrared, Light Detection and Ranging (LiDAR), Radar, side-scan radar, temperature, salinity, Total Dissolved Solids (TDS), and compound specific sensors. In some embodiments, the features recorded can include, but are not limited to, geolocation, topology, vegetative coverage, biodiversity, invasive species, soil and sediment types, water flow rates and direction, temperature, humidity, salinity, oxygen content, presence of toxic compounds, carbon content of the biomass, carbon content of the soils and sediments and/or other types of features to be recorded.

Mapping System 3: Submersible system. In some embodiments, the Mapping System can be a submersible water vehicle. In some embodiments, the submersible mapping system can have buoyancy control to allow the system to operate at the water surface or below the water surface of the aquatic ecosystem. In some embodiments, the submersible mapping system can vary the buoyancy to be positive and remain on the water surface or to be negative buoyancy to drop below the water surface to the floor of the target destination. In some embodiments, the submersible mapping system can be an automated, autonomous system. In some embodiments, the submersible mapping system can be tethered to a surface mobile or docking system. In some embodiments, the submersible mapping system can have on-board power, control systems, and guidance to operate the sensors. In some embodiments, the submersible mapping system can include a number of sensors that are mounted or tethered to this system in order to collect and record data to map below water surface features. In some embodiments, sensors that can be included, but are not limited to, are visual, infrared, near-infrared, Light Detection and Radar (LiDAR), Radar, side-scan radar, temperature, depth, salinity, total dissolved solids (TDS), compound specific sensors, carbon content of biomass, and carbon content of the soils and sediments. In some embodiments, the features recorded can include, but are not limited to, topology, geolocation, vegetative coverage, biodiversity, invasive species, soil types, water flow rates and direction, temperature, salinity, oxygen content, presence of toxic compounds and/or other types of features to be recorded.

### Surface Docking and Take-off and Landing Platforms:

Surface Docking Platform. In one embodiment, the Surface Docking Platform can provide a surface-based system for the operation and retrieval of the various mobile platforms (e.g., surface, submersible, and floor robotic mobile platforms). In at least one embodiment, the docking platform has positive buoyancy to remain on the water surface. In some embodiments, the docking platform can be an automated, autonomous system (or semi-autonomous). In some embodiments, the docking platform can be a manned system. In some embodiments the docking platform can be tethered to another mobile or stationary system. In some embodiments, the docking platform can include a tether to the mobile platforms for power, data, and guidance. In some embodiments, the docking platform can provide interfaces for power and data. In some embodiments, the docking platform can include a powered lift for the surface, submersible, and/or floor robotic mobile platforms to allow each of these to dock and be lifted out of the water and stored on the lift or on the deck of the docking platform. In some embodiments, the docking platform can refill the seed, seedling, and/or other organism delivery structures on the docked mobile platforms.

Take-off and Landing Platform. The key objective for the Take-off and Landing Platform is to provide a stable surface for take-off and landing of the aerial-based systems (e.g., Aerial Mobile Platform, Aerial Guidance System, and Aerial Mapping System). In at least one embodiment, the Take-off and Landing platform has positive buoyancy to remain on the water surface. In some embodiments, the take-off and landing platform can be an automated, autonomous system (or semi-autonomous). In some embodiments, the take-off and landing platform can be a manned system. In some embodiments the take-off and landing platform can be tethered to another mobile or stationary system. In some embodiments, the take-off and landing platform can include a tether to the mobile platforms for power, data, and guidance. In some embodiments, the take-off and landing platform can provide one or more interfaces for power and data. In some embodiments, the take-off and landing platform can include a flat, stable surface above the deck of the take-off and landing platform for the aerial mobile platforms to take-off and land. In some embodiments, the take-off and landing platform can refill the seed, seedling, and other organism delivery structures on the landed aerial mobile platforms.

Applicability Matrix Table: In one embodiment, there can be a number of common elements to how they are utilized across the mobile platforms. The applicability matrix table illustrates an example of how these common elements are distributed and used. The table is organized in two parts. The first part indicates which of the different Organism Delivery Structures (left side column) are used by which of the Mobile Platforms (top row). The second part indicates which of the design features (left side column) are used by the which of the Mobile Platforms.

TABLE 1
Applicability Matrix Table.

| | | | |
|---|---|---|---|
| Aerial | Surface | Subsurface | Floor Robotic |

Organism Delivery Structure

| | | | | |
|---|---|---|---|---|
| Direct Seeding | X | X | | |
| Seedballs | X | X | X | X |
| Seed Pucks | X | X | X | X |
| Seedling Cone | X | X | X | X |
| Drop bags | X | X | X | |
| Deployable Mats | X | X | | |

Design Features

| | | | | |
|---|---|---|---|---|
| Gravity | X | X | X | X |
| Belt-Feeder Single or | X | X | | |
| Multi-Channel | | | | |
| Drop Trough with or | X | X | X | X |
| without guide tube | | | | |
| Air filled bell chamber | | | X | X |
| Launcher Rotational | X | X | | |
| or Spinning | | | | |
| Pressurized Gas Fired | | X | | |
| Spreader | X | X | | |
| Pusher/Plunger | | | X | X |
| Other weighted and/or | X | X | X | X |
| sinkable structures | | | | |
| Electromechanical | | | X | X |
| Robotic arm | | | | |

Note:
“X” means feature is applicable to this platform.

### Top-Level Integrated System

The disclosed invention is a method with an integrated system for the distribution of organisms for the restoration of aquatic ecosystems and aquaculture using a variety of platforms as described, each of which will be described in detail in the following sections.

Numerous examples of the mobile organism delivery structures, mobile platforms, subsystem payloads, electromechanical robotic arm, docking and landing platform, guidance system, mapping system, and electronic and control systems are presented to show how the integrated system might be deployed and how each of these might be used and operated separately and/or together. This is not a limitation of the scope of the disclosure, and all lines of the disclosure are still applicable whether they are included in the example or not.

In at least one embodiment, a data collection system can be used to collect above and below water surface data to determine the best locations and distribution patterns for the organisms. The data to be collected can be from sensors mounted on each of the mobile platforms and/or other supporting systems. Data to be collected and recorded can include, but are not limited to, topology, temperature, humidity, salinity, pH, existing vegetation, other types of data, and/or a combination therein. In at least one embodiment, data analysis software can use the collected data and third-party data to determine the locations and distribution patterns which can be programmed into the guidance system software to direct the mobile platforms to the target destination.

In at least one embodiment, one or more of the mobile platforms and one or more of each of the types of mobile platforms can be operated simultaneously as an integrated system to distribute the organism delivery structures in the target destinations. In at least one embodiment, each of the mobile platforms can operate as a separate or standalone device.

In at least one embodiment, one or more of the mobile platforms can be directed in coordination by the guidance system to restore a predetermined distribution pattern, overlapping but not repeating.

In at least one embodiment, one or more of the mobile platforms can include a variety of sensors previously described that are connected to the electronics control system which can be used to improve the navigation and guidance of the platform to its target destination.

### Organism Delivery Structures and Methods

### General

The organisms can be prepared in a number of methods as treated and untreated seeds and as Organism Delivery Structures in order to be compatible with the Subsystem Payloads and for use with the various Mobile Platforms. Primary subsystem payloads can distribute seeds by direct seeding and other organisms contained in the Organism Delivery Structures (e.g. seedballs, seed pucks, seedling cones, drop bags, and/or deployable mats). In some embodiments, each of the organism delivery structures can have some common elements in the manufacturing. The primary purpose is to distribute live organisms to a target destination. In at least one embodiment, other than for direct seeding, each of the organism delivery structures can include soil or sediment, biochar or activated carbon, nutrients (such as nitrogen, phosphorous, potassium, calcium, sulfur, and/or magnesium), micronutrients, organic or inorganic substances, fertilizers, gels, hydrogels, anti-predation additives, and one or more seeds or seedlings, bacteria, microbes, fungi, and/or other organisms. In some embodiments nutrients and micronutrients may be natural or synthetic. In some embodiments, additional organisms necessary for plant health and growth can be included, such as, but not limited to, fungi, bacteria, moss, and protists. Specific embodiments for each of the organism delivery structures and variations specifically designed for each of the mobile platforms are provided in the following sections.

### Direct Seeding

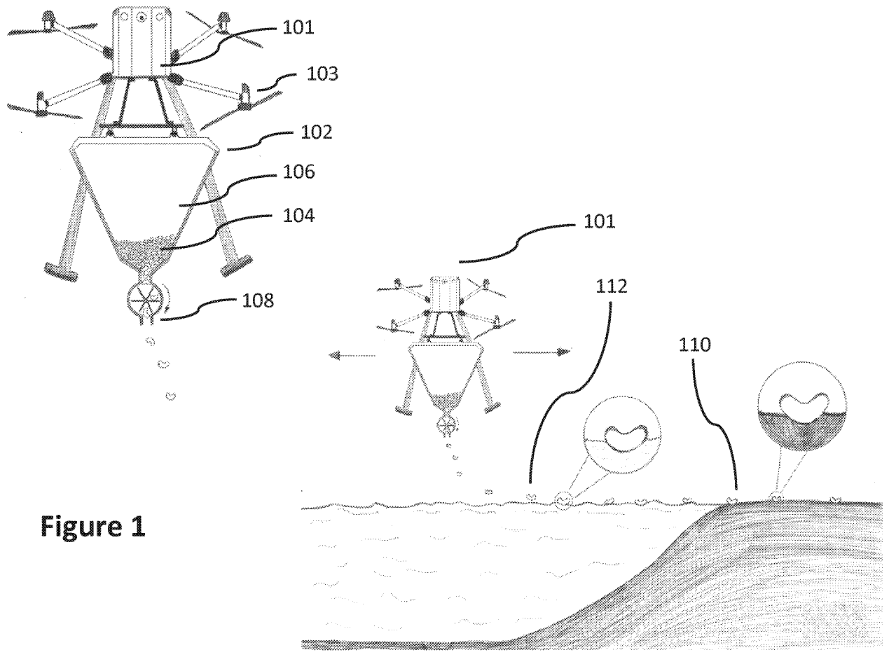

FIG. 1 is an illustration of direct seeding to deliver treated and untreated seeds to a target destination, in accordance with embodiments of the present invention. In this embodiment, the bulk seeds (104) can be placed into a central storage compartment (106) of the direct seeding subsystem payload (102). In some embodiments, the direct seeding subsystem payload can be designed to accommodate a variety of seed sizes and types. In some embodiments, the seeds can be loaded into the central storage of the subsystem payload and can be released through a mechanical actuator (108) and can be distributed according to the description of the payload and the mapping system generated distribution map.

In one embodiment, a mobile platform (101) includes a set of rotors (103) that enable the mobile platform to move through the air so as to move to deliver the Organism Delivery Structures to the desired location according to the distribution pattern.

In one embodiment, the seeds can be distributed by the mobile platform (101) to the top of a soil or sediment environment (110). In one embodiment, the seeds can be distributed to the top of a water environment (112).

### Seedballs

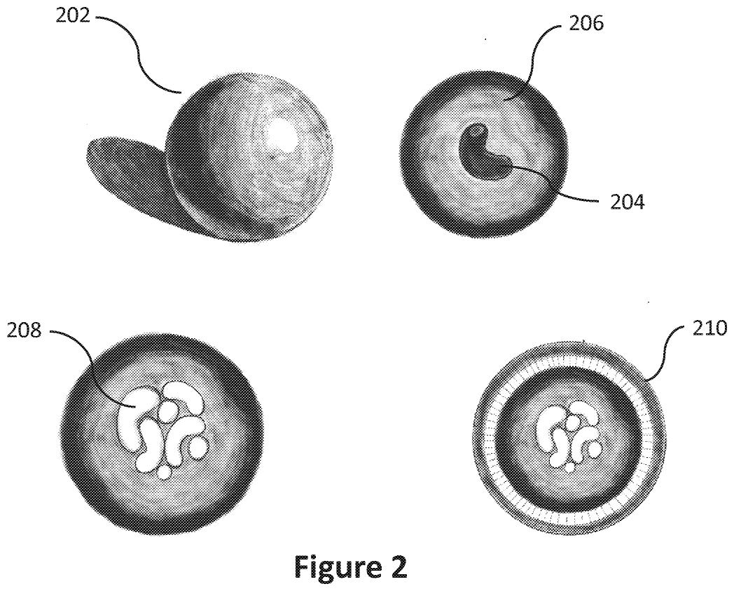

FIG. 2 is an illustration of an example of a spherical Seedball (202) and its components, in accordance with embodiments of the present invention. In one embodiment, a seedball (202) can comprise a seed (204) encased in a mixture of clay or other material (206) to serve as a structural element when dried, a compost for a nutrient base, activated carbon/charcoal, any anti-predation materials, and/or a combination therein. In at least one embodiment, the seedball organism delivery structure can be approximately spherical in shape and can be designed specifically for use in an aquatic ecosystem. In some embodiments, the mechanical structure due to the clay component can allow the seedball to be manipulated and feed through the variety of subsystem payloads and to be released via a pressurized air-gun, spring-loaded launcher, spinning wheel launcher, or any other type of mechanism, and from any of the mobile platforms as described, from a seedball specific subsystem payload. In some embodiments, the density of the formulated seedball, including the seeds, can be denser than water such that it can sink in the target aquatic environment, which can be accomplished by the additional structural materials or a separate weight.

In one embodiment, the seedball can include one or more seeds of the same species (208).

In one embodiment, the seedball can include one or more seeds of a mix of species.

In one embodiment, the seedball can include, in addition to seeds, a bacteria, fungi, or other organisms.

In one embodiment, the seedball can include a bacteria, fungi, or other organisms, without a seed as a means for soil restoration.

In one embodiment, an impermeable coating (210) can be applied to the exterior surface to reduce the rate of dissolution once the seedball is deposited or released into a water environment.

In one embodiment, a method of preparing and manufacturing the seedballs can be as follows:
Step 1: Sieve the compost so that the compost is small grain size and relatively uniform, with non-desirable detritus removed.
Step 2: Mix the dry ingredients: powdered clay, compost, activated carbon/biochar. While in one embodiment, the mixing rate is 60% clay, 35% compost, and 5% activated carbon/biochar, in other embodiments, the mixing rate can vary depending upon the species and specific environmental conditions of the target destination for distribution.
Step 3: Add the seeds and mix well. The number of seeds is at least enough to have one or more on average within each seedball produced in the batch. The distribution of seeds will be random.
Step 4: Add the bacteria, fungi, or other organisms and mix well.
Step 5: Add any anti-predated additives and mix well.
Step 6: Add water and gently mix so that the consistency is moist throughout but not overmixed.

The quantity of water should be just sufficient to thoroughly moisten the mixture enough so that it forms a dough-like consistency.

For manual formulation, follow steps 7-10, for automated manufacturing, follow steps 11-12.
Final Steps Continue for Both Methods of Formulation with Step 13.
Step 7: A portion of the seedball “dough” is put into a sausage gun (a typical commercially available device for making sausage food items).
Step 8: Use the sausage gun to produce a bead. The diameter of the bead is dependent upon the seed size. It must be larger than the seed to ensure that the seed is whole and that the seedball diameter is large enough to contain one or more whole seeds and to provide enough structure to hold the seedball together. The range of the diameter is typically about, but not limited to, 6 mm to 30 mm.
Step 9: The bead is transferred to a cutting and rolling tray. In one embodiment, the cutting and rolling trays can have a two-piece structure with a top and base part made of molded or 3d printed parts. Furthermore, the cutting and rolling can have a series of one or more circular channels of matching diameter to the bead. The bead is placed across the channels of the base part. The top part has handholds and is placed over the base part to line up the channel with a guide slot. The top part is pressed down to cut the bead to the correct size. The top part is then slide back and forth along the length of the channels. This causes the bead to roll and form a spherical ball within the channel.
Step 10: The formed seedballs are transferred to a surface to allow drying. Skip to step 13.
Step 11: For automated formulation, the seedball mixture “dough” is transferred to a commercially available food equipment that will automatically form the bead and cut and roll-out the seedballs.
Step 12: The formed seedballs are transferred to a surface to allow drying.
Step 13: The seedballs can be air-dried, placed in a desiccator tray, in a low-temperature oven, or a number of other methods to dry the moist seedballs.
Step 14: An impermeable coating may be applied, as appropriate, to the exterior surface of the seedballs.
Step 15: The completed seedballs are placed in storage until ready for distribution in the target destination.

In at least one embodiment, an RFID chip or another type of electronic identifier can be included in the seedballs structure to allow detection and mapping of where the seedball actually lands in the target destination.

### Seed Pucks

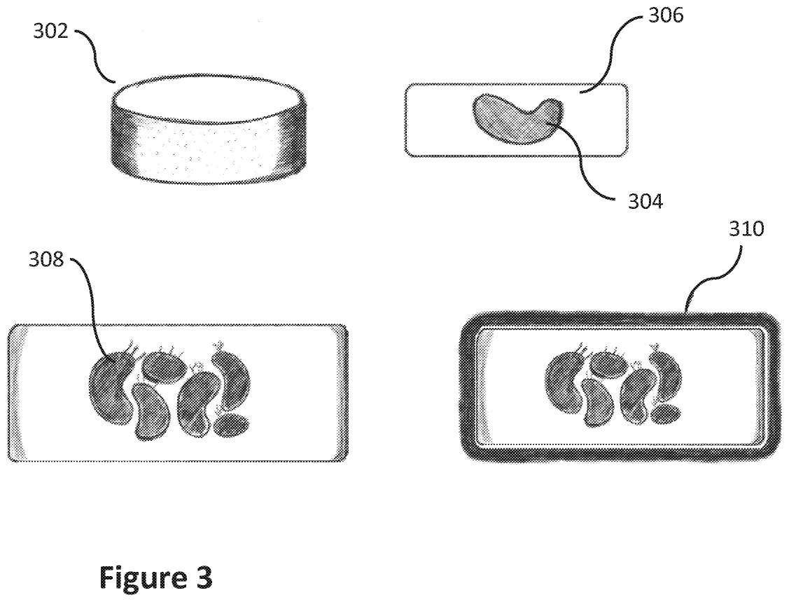

FIG. 3 is an illustration of an example of a Seed Puck (302) and its components, in accordance with embodiments of the present invention. In this embodiment, a seed puck (302) can comprise a seed (304) encased in a mixture of clay or other material (306) to serve as a structural element when dried, a compost for a nutrient base, an activated carbon/charcoal, and any anti-predation materials. In some embodiments, the Seed Puck Organism Delivery Structure can be a flat cylinder “puck-like” in shape (302) and can be designed specifically for use in an aquatic ecosystem. In some embodiments, the mechanical structure due to the clay component can allow the seed puck to be manipulated and fed through the variety of subsystem payloads and can be released via a spring-loaded launcher, spinning wheel launcher, gravity drop, or any other type of mechanism and from any of the mobile platforms as described, from a seed puck specific subsystem payload. In some embodiments, the density of the formulated seed puck, including the seeds, can be denser than water such that it can sink in the target aquatic environment, which is accomplished by the additional structural materials or a separate weight.

In at least one embodiment, the seed puck can include one or more seeds of the same species (308).

In at least one embodiment, the seed puck can include one or more seeds of a mix of species.

In at least one embodiment, the seed puck can include, in addition to the seed, a bacteria, fungi, or other organism.

In at least one embodiment, the seed puck can include a bacteria, fungi, or other organism, without a seed as a means for soil restoration.

In at least one embodiment, an impermeable coating (310) can be applied to the exterior surface to reduce the rate of dissolution once the seed puck is deposited or released into a water environment.

In at least one embodiment, an RFID chip or another type of electronic identifier can be included in the seed puck structure to allow detection and mapping of where the seed puck actually lands in the target destination.

### Seedling Cones

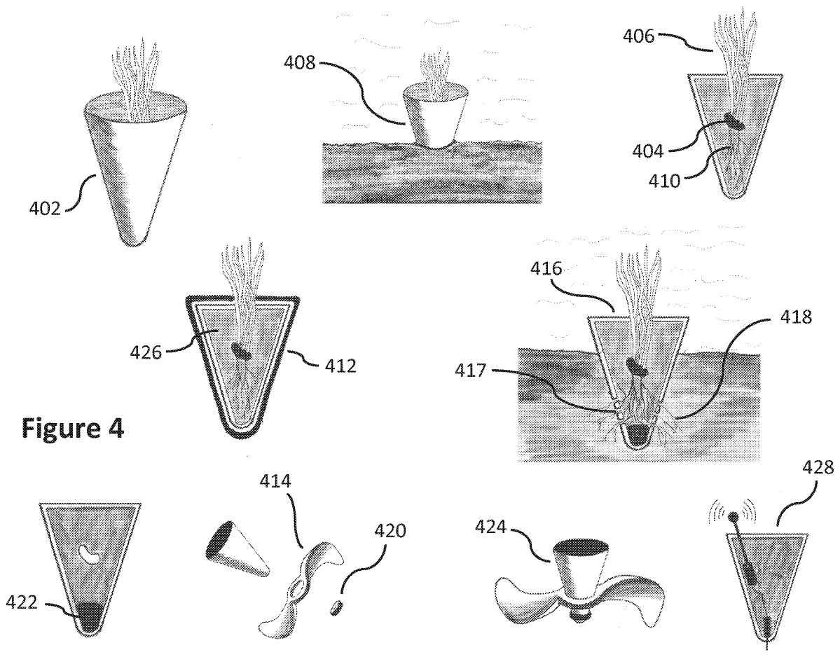

FIG. 4 is an example of a Seedling Cone (402), its components, and various design features, in accordance with embodiments of the present invention. In this embodiment, a Seedling Cone Organism Delivery Structure can be a conical structure (402) (or approximate conical structure) in which seeds (404) are either grown to a seedling (406) within the structures, or a grown seedling is inserted after growth. In some embodiments, the seedling cones can be designed to plant a growing seedling into a sediment of a water-based ecosystem (408). In some embodiments, the seedling cones, including the seedling and all materials, can have a density higher than water so that it can sink in a water-based environment. In some embodiments, seeds can be placed within the structure and can be distributed in the target destination environment before germination and growing into a seedling.

In some embodiments, the seedling cones (402) can comprise a composite multi-section molded hollow cone bodies and can include a nutrient enriched section or band at the seedling side root area, the bodies carrying internally, a compacted growing medium (410) within which can be positioned a seedling either grown therein or transplanted therein. In some embodiments, the growing medium can include bacteria and/or fungi to promote the growth of the seedling. In some embodiments, anti-predation additives can be added to the growing medium (426) or as an exterior coating (412) to the seedling cones in order to reduce scavenging by local fish and sea animals, bacteria, fungus, insects, or any other organism that would consume the seed or seedling.

In some embodiments, the bodies may bear a molded, weighted nose cone and may also bear by way of a collar or as a molded feature, hydrodynamic propelling wing(s) (414) to increase the drive velocity of the body for forced penetration of the surface sediment being planted, above or below the water surface. In this embodiment, the top of the seedling cone can be open to allow the seedling to sprout within the seedling cone structure (416). In some embodiments, the tip of the seedling cone can have a small diameter axial drainage hole. In some embodiments, seedling cone can have some holes along the side of the cone (417) to allow roots to grow into the exterior sediment (418) or planting medium while the seedling cone material degrades leaving just the growing plant.

In some embodiments, the body of the seedling cone may be made from either a water soluble or insoluble, solid bacteria-degradable material capable of being formed to the desired shape and having the necessary mechanical strength. In some embodiments, alternative materials for fabrication of the seedling cone can include, but are not limited to, inorganic materials such as clays or stone, ceramic, bioplastics, or other polymers or manufactured substrates. In some embodiments, a hydrophobic coating can be applied to the outside of the seedling cone to allow the seedling cone to pass through the water with less friction.

In some embodiments, the weighted nose cone can be a separate structure (420) that is added prior to distribution. In some embodiments, the weighted nose cone can be a part of the manufactured structure (422).

In some embodiments, a separate hydro-dynamic wing (414) can be added to the seedling cone structure in order to induce a spin that can allow the seedling cone to drop through the water at a more stable and faster rate. In some embodiments, this will increase the boring and penetration force of the seedling cone as it enters the sediment. In other embodiments, the water-dynamic wing can be a part of the manufactured structure (424).

In some embodiments, the seedling can be grown within the body of the hollow seedling cone structure, the body being filled with a growing medium (426) such as loam or sediment with additional nutrients and/or activated carbon, biochar, bacteria, and fungi added as appropriate for the specific seed species being grown. In some embodiments, a seed may be placed within the growth medium, with the seed germination and seedling growth taking place all within a greenhouse or other location appropriate for the species, prior to distribution by the mobile platforms. In some embodiments, the seedling can be grown in a separate system and transferred to the seedling cone. In some embodiments, a seed can be inserted into the growth medium and distributed by the mobile platform as a seed rather than as a seedling, with germination and growth taking place in situ of the target destination environment.

In some embodiments, the seed or seedling can be inserted to a variable depth within the seedling cone to allow germination and/or growth of roots. In some embodiments, the seedling cone may include a rigid top component that helps to secure the seed and/or seedling within the cone.

In at least one embodiment, an RFID chip can be included in the seedling cone structure to allow detection and mapping of where the seedling cone actually lands in the target destination.

In at least one embodiment, the seedling cone can be outfitted with sensors (428) instead of a seed or seedling. In some embodiments, sensors can include, but are not limited to, temperature, pH, CO2, Oxygen, light level, inorganic molecules, organic carbon and other nutrients, a power source, an onboard micro-processor, and an electronics and communication system. In some embodiments, the communication system may communicate with any of the mobile platforms or a buoy.

### Drop Bags

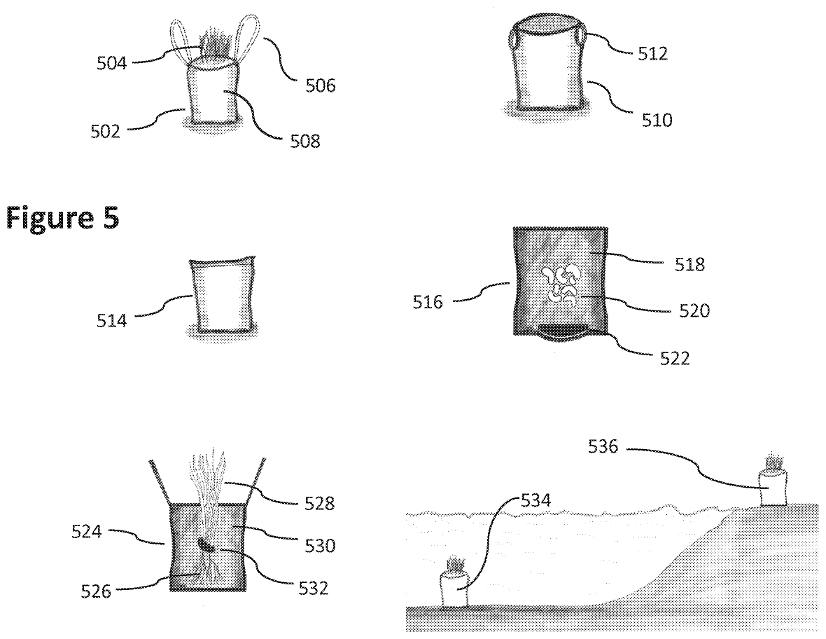

FIG. 5 is an illustration of an example of different Drop Bags (502, 510, 514, 516, 524), in accordance with embodiments of the present invention. In one embodiment, one or more drop bags (502, 510, 514, 516, 524) can be flexible, non-rigid, and/or semi-rigid containers and can be manufactured out of a biodegradable material. In some embodiments, a drop bag (e.g., 502, 510, 514, 516, 524) can have an open top (502, 510, 524) and can allow seedlings to grow up and out. In some embodiments, the drop bags are closed like a bean bag (514, 516). In some embodiments, the drop bag has a strap (506) or a ring (512) that can be made of the same material as the bag or can be a biodegradable plastic. In some embodiments, this strap (506) or ring (512) can be used to connect the drop bag organism delivery structure to the subsystem payload for transportation and deployment in the target destination. In some embodiments, the ‘Bean Bag” configuration can be dropped directly from the subsystem payload. In at least one embodiment, a drop bag (502, 510, 514, 516, 524) can be filled with soil and/or sediment, biochar or activated carbon/charcoal, nutrients, anti-predation additives, seeds, seedlings, fungi, and/or other organisms (508, 518, 530). In this embodiment, the texture of the drop bag can be a mesh, weave, extruded, or any other type of material formation that will allow the containment of the other components while allowing the roots (526) of the germinated seed or seedling (532) to pass through the wall of the bag and establish within the floor of the water-based system. In some embodiments, one or more seeds (520) can be placed within the soil/sediment to be distributed and then germinated once in situ at the target destination. In some embodiments, one or more seeds can be placed within the drop bags and germinated and grown into seedlings prior to transportation and distribution (504, 528) in the target destination. In some embodiments, one or more germinated seedlings can be transferred to a drop bag prior to deployment. In one embodiment, the drop bags can be weighted (522) to ensure that the drop bag falls bottom-side down when released and can sink to the floor within a water environment with the bottom-side down (534) or bottom-side down when released to a soil surface (536).

### Deployable Mats

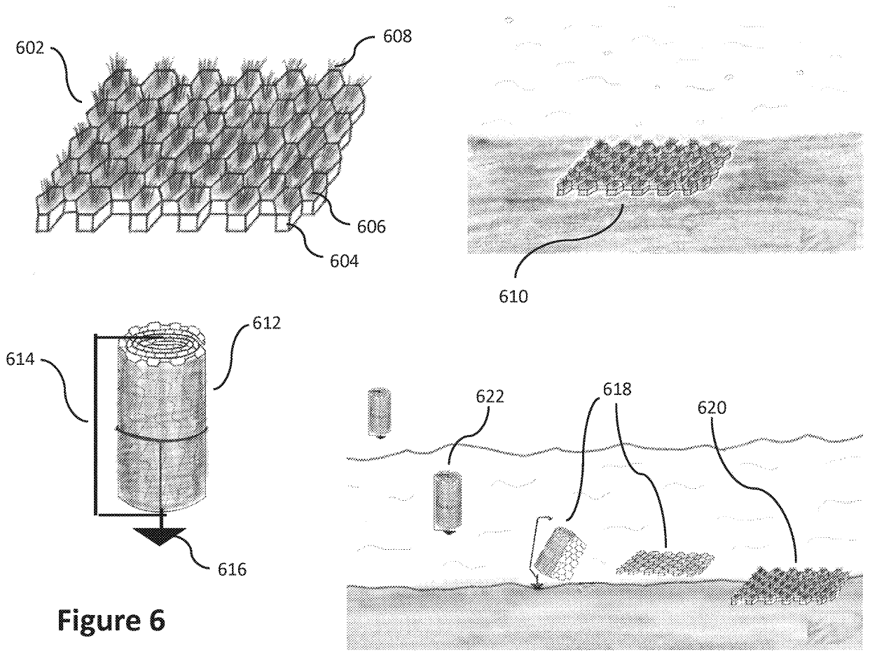

FIG. 6 is an illustration of an example of a Deployable Mat (602) and its components in a flat deployed configuration and rolled configuration, in accordance with the embodiments of the present invention. In this embodiment, Deployable Mats (602) can be a meshed structure with open spaces (604) that lies flat on a target destination surface, above and below the surface of the water (610). In this embodiment, the Deployable Mats can be manufactured with a biodegradable material. In some embodiments, the open spaces (604) can be filled with soil or sediment (606), as appropriate for the target destination environment. In some embodiments, seeds are placed within the soil/sediment and can be germinated and grown into seedlings (608) prior to distribution. In some embodiments, the deployable mat organism delivery structure can be moved to the target destination prior to germination and growth of the seeds. In some embodiments, the Deployable Mats can be distributed in an extended, flat configuration (610). In some embodiments, the Deployable Mats can be rolled (612) for transportation to the target destination. In some embodiments, the rolled configuration of the deployable mat has a spring-loaded trigger (614) that will release and extend the mat when it reaches the target destination (620). In some embodiments, the deployable mat in the rolled configuration can be weighted on one end with a trigger mechanism (616) so that it will sink that end downwards (622). In some embodiments, multiple mats can be carried and distributed by the aerial and surface mobile platforms.

### Other Types of Organism Delivery Structures

A variety of other structures can be distributed with the various mobile platforms. These include lightweight grids, domes, and concrete structures. These can be used as a fixed point for a variety of organisms in the near-shore and subsurface environments.

### Mobile Platforms

### General

In one embodiment, a role of the mobile platforms is to transport and distribute the organism delivery structures to/in the target destination environment. In some embodiments, the mobile platforms can be an aerial, surface, submersible, and/or floor robotic system. In some embodiments, the design and configuration of each of the mobile platforms is specific to the subsystem payloads and the operational environment.

In at least one embodiment, the mobile platform can include a battery, fuel tank, and/or other means of storing or generating energy for the operation of the platform components and subsystem payloads. In some embodiments, the mobile platforms can include connection hardware to attach to the subsystem payloads to the mobile platform.

In some embodiments, mobile platforms can include electronic control systems for operation of the mobile platform, command and control of subsystems payloads, sensors, communication with other components of the integrated system, GPS, inertial navigation system processor, and other guidance system hardware and software. Specific mobile platforms are detailed as follows.

### Aerial Mobile Platform

In some embodiments, the aerial mobile platform may consist of a drone/UAV (FIG. 1, 101) or other type of aerial vehicle with a subsystem payload that can carry and distribute a variety of organism delivery structures.

In at least one embodiment, the aerial vehicle can be a manned aircraft of fixed wing or rotor. In other embodiments, the aerial mobile platform can be a remote controlled, unmanned aerial vehicle (UAV). In other embodiments, the aerial mobile platform can be an autonomous, unmanned aerial vehicle.

In some embodiments, the aerial mobile platform can include a propulsion component (FIG. 1, 103) suitable for aerial movement of the specific platform, e.g., fixed wing, multi-rotor, and vertical-take-off-and-landing (VTOL). In at least one embodiment, the propulsion component can comprise one or more propellers.

### Surface Mobile Platform

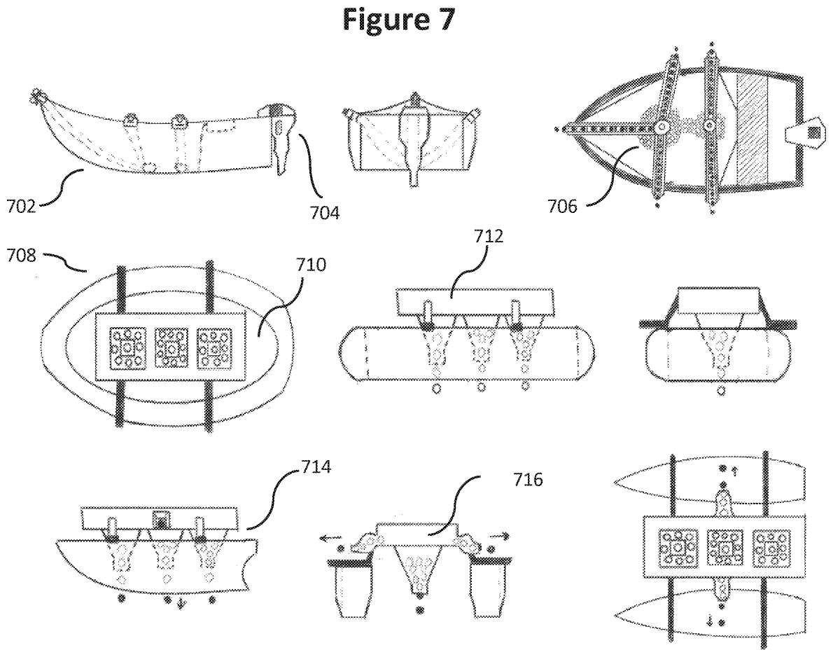

FIG. 7 is an illustration of an example of different Surface Mobile Platforms, in accordance with the embodiments of the present invention. In some embodiments, the surface mobile platform can consist of a boat with a closed bottom (702). In some embodiments, the surface mobile platform can consist of a donut shaped boat (708) with an open bottom (710). In some embodiments, the surface mobile platform can consist of a catamaran (714).

In at least one embodiment, the surface mobile platform can include the subsystem payload (706, 712, 716) (seedling cone, seedballs, seed pucks, etc.) matched with one or more of the organism delivery structures (seedling cone, seedballs, and/or seed pucks) each of which can contain one or more seeds, seedlings, bacteria, fungi, or other organisms; the subsystem payload can include trays or magazines in the case of the seedling cone payload, the seedball payload can include a central storage container. In some embodiments, the Surface Mobile Platform can include an electronic control system and computing device (not illustrated) which controls the electromechanical system for releasing the organism delivery structure and is connected to any sensors that may be attached to the surface mobile platform, and which may be connected to the guidance system.

In at least one embodiment, the surface mobile platform can be a manned boat or other type of vehicle that maintains a positive buoyancy on a water surface. In some embodiments, the surface mobile platform can be a remote controlled, unmanned water vehicle. In some embodiments, the surface mobile platform can be an autonomous, unmanned water vehicle.

In at least one embodiment, the guidance system can send signals to the electronics and control system to adjust a steering mechanism to follow the determined pathway to the target destination.

In at least one embodiment, the surface mobile platform can include a propulsion component (704) suitable for aquatic movement of the device. In at least one embodiment, the propulsion component can comprise a propeller. In at least one embodiment, the propulsion component can comprise a pump-jet, impeller, or other mechanism for propulsion. In some embodiments, the propulsion component may further include one or more steering mechanisms, such as rudders, hydroplanes, ballast tanks, and so forth.

### Submersible Mobile Platform

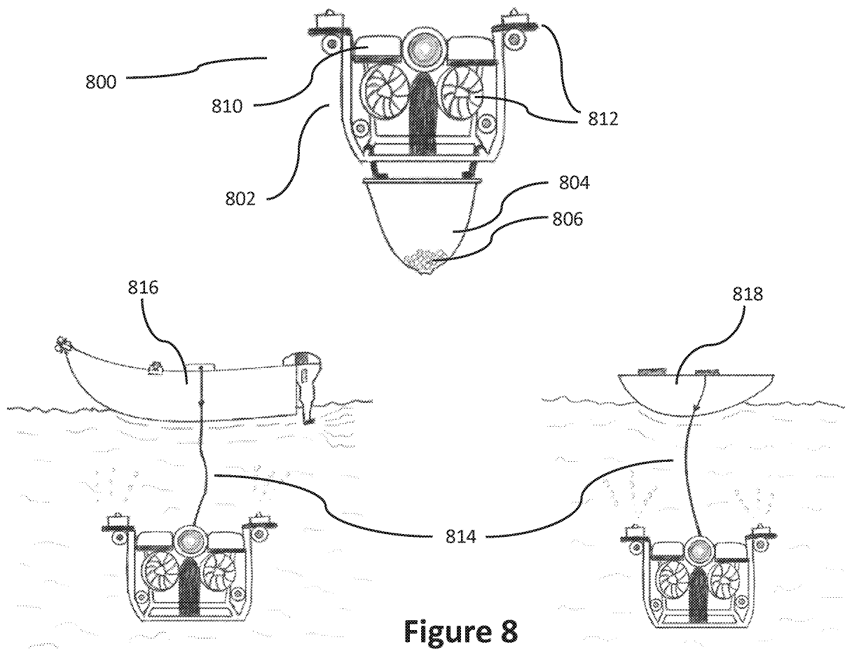

FIG. 8 is an illustration of an example of a Submersible Mobile Platform (800), in accordance with the embodiments of the present invention. In some embodiments, the submersible mobile platform can consist of a water-based vehicle (802) with a subsystem payload (804) that can carry and distribute a variety of organism delivery structures (806).

In at least one embodiment, the submersible mobile platform (800) can include the subsystem payload (seedling cone, seedballs, seed pucks, etc.) matched with one or more of the organism delivery structures (seedling cone, seedballs, and/or seed pucks) each of which can contain one or more seeds, seedlings, bacteria, fungi, or other organisms. In some embodiments, the seedling cone subsystem payload can include trays or magazines. In some embodiments, the seedball payload can include a central storage container which can be a pressurized bell chamber (804) or other design to keep the seedballs dry until delivery. In some embodiments, the seed puck payload can include a number of tubes which may be pressurized to keep the seed pucks dry until delivery. In some embodiments, the submersible mobile platform (800) can include an electromechanical robotic arm to aid in the delivery and placement of the organism delivery structures (seedling cones, seedballs, seed pucks). In some embodiments, the submersible mobile platform (800) can include an electronic control system and computing device which controls the electromechanical system for releasing the organism delivery structure, that also controls the electromechanical robotic arm when attached to the submersible mobile platform, can be connected to any sensors that can be attached to the submersible mobile platform, and which can be connected to the guidance system.

In at least one embodiment, the submersible mobile platform (800) can be a remotely operated vehicle (ROV). In at least one embodiment, the submersible mobile platform (800) can be an autonomous vehicle.

In at least one embodiment, the submersible mobile platform (800) can include a compressed air tank and ballast tank (810) to control buoyancy, which can be positive, negative, or neutral. In at least one embodiment, the mobile platform electronics and control system can adjust the buoyancy. In at least one embodiment, the guidance system can send signals to the electronics and control system to adjust the buoyancy and a steering mechanism to follow the determined pathway to the target destination.

In at least one embodiment, the submersible mobile platform (800) can include a propulsion component (812) suitable for surface and subsurface movement of the device. In at least one embodiment, the propulsion component (812) can comprise a propeller. In at least one embodiment, the propulsion component (812) can comprise a pump-jet, impeller, or other mechanism for propulsion. In at least one embodiment, the propulsion component (812) can further include one or more steering mechanisms, such as rudders, hydroplanes, ballast tanks, and so forth.

In at least one embodiment, the trays, magazine, electromechanical robotic arm, or any method/mechanism of release of the organism delivery structure can allow the seedling cone, seedballs, seed puck or other delivery structure to be distributed in the target destination environment.

In at least one embodiment, the submersible mobile platform may be tethered (814) to the surface mobile platform (816) and/or docking platform (818) for power, data and communications, guidance and control, and/or to allow the surface mobile platform or docking platform to deposit or retrieve the submersible mobile platform to/from the target destination.

### Floor Robotic Mobile Platform

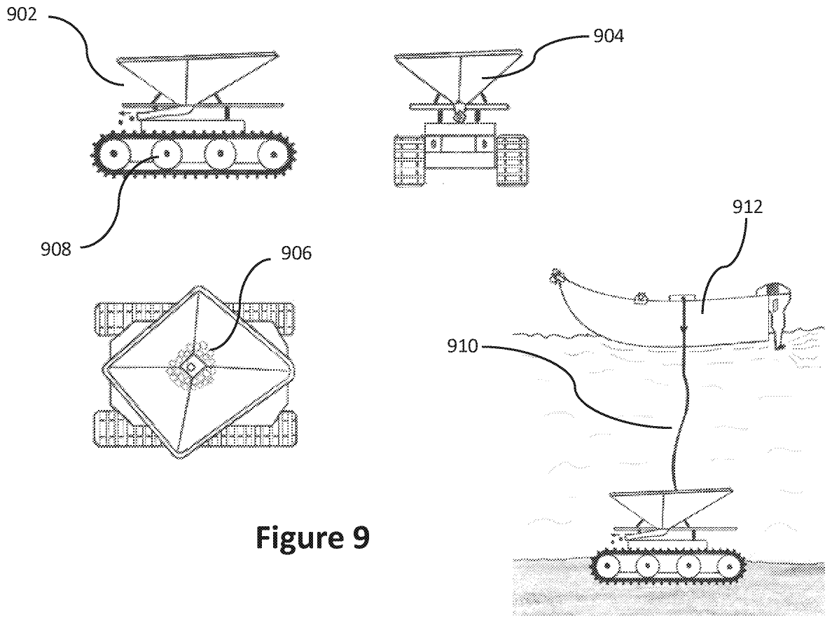

FIG. 9 is an illustration of an example of a Floor Robotic Mobile Platform, in accordance with embodiments of the present invention. In some embodiments, the floor robotic mobile platform can consist of a water-based vehicle (902) with a subsystem payload (904) that can carry and distribute a variety of organism delivery structures (906).

In at least one embodiment, the floor robotic mobile platform can include the subsystem payload (cone seedling, seedballs, seed pucks, etc.); one or more of the organism delivery structures (cone seedling, seedballs, seed pucks, etc.) each of which can contain one or more seeds, seedlings, bacteria, fungi, other organisms, and/or a combination therein. In some embodiments, the seedling cone subsystem payload can include trays or magazines. In some embodiments, the seedball payload can include a central storage container which can be a pressurized bell chamber (904) or other design to keep the seedballs dry until delivery. In some embodiments, the floor robotic mobile platform can include an electromechanical robotic arm (not illustrated) to aid in the distribution and placement of the organism delivery structures (seedling cones, seedballs, seed pucks). In some embodiments, the floor robotic mobile platform can include an electronic control system and computing device which can control the electromechanical system for releasing the organism delivery structure, can control the electromechanical robotic arm when attached to the robotic floor mobile platform, can be connected to any sensors that can be attached to the robotic floor mobile platform, and/or which can be connected to the guidance system.

In at least one embodiment, the robotic floor mobile platform can be a remotely operated vehicle (ROV). In at least one embodiment, the floor robotic mobile platform can be an autonomous vehicle.

In at least one embodiment, the robotic floor mobile platform can include a compressed air tank and ballast tank to control buoyancy, which can be positive, negative, or neutral. In at least one embodiment, the mobile platform electronics and control system can adjust the buoyancy. In at least one embodiment, the guidance system can send signals to the electronics and control system to adjust the buoyancy and a steering mechanism to follow the determined pathway to the target destination.

In at least one embodiment, the floor robotic mobile platform can include a propulsion component (908) suitable for subsurface movement of the device on the floor of the target destination environment. In at least one embodiment, the propulsion component can comprise motorized wheels, tracks (908), or other mechanisms. In at least one embodiment, the propulsion component can further include one or more steering mechanisms, such as ballast tanks, turnable wheels, and so forth.

In at least one embodiment, the trays, magazine, electromechanical robotic arm, or any method/mechanism of release of the organism delivery structure can allow the seedling cone, seedballs, seed pucks, other delivery structure, and/or a combination therein to be distributed in the target destination environment.

In at least one embodiment, the robotic floor mobile platform can be tethered (910) to the surface mobile (912) platform and/or docking platform for power, data and communications, guidance and control, and/or to allow the surface mobile platform or docking platform to deposit or retrieve the robotic floor mobile platform to/from the target destination.

### Subsystem Payloads

### General

In one embodiment, a role of the subsystem payload is to store, transport, and/or distribute the organism delivery structures to/in the target destination environment. The design and configuration of each of the subsystem payloads is specific to the type of organism delivery structure and the mobile platform to which it is attached.

In at least one embodiment, the subsystem payload can include a power, data, and/or command and control coupling to the mobile platform. In at least one embodiment, subsystem payloads can include connection hardware to attach to the mobile platform. In at least one embodiment, the subsystem payload can include an electronics and control systems for the operation of the payload and for communication with the mobile platform and other components of the integrated system.

In some embodiments, a subsystem payload can have one or more sensors that determine when the organism delivery structures have been distributed and when a reload is necessary. In some embodiments, the determination of the need for a refill of organism delivery structures can be with one or more sensors (mechanical, electrical, and/or electromechanical) integrated into the feeder systems, or within the central storage compartment, and/or by an RFID chip or another type of electronic identifier in the organism delivery structure.

In at least one embodiment, the subsystem payloads can be independent, detachable devices from the mobile platform. In at least one embodiment, the subsystem payloads can have separate power supplies to power the subsystem payload independent of the mobile platform. Specific subsystem payloads are detailed as follows.

### Direct Seeding Subsystem Payload

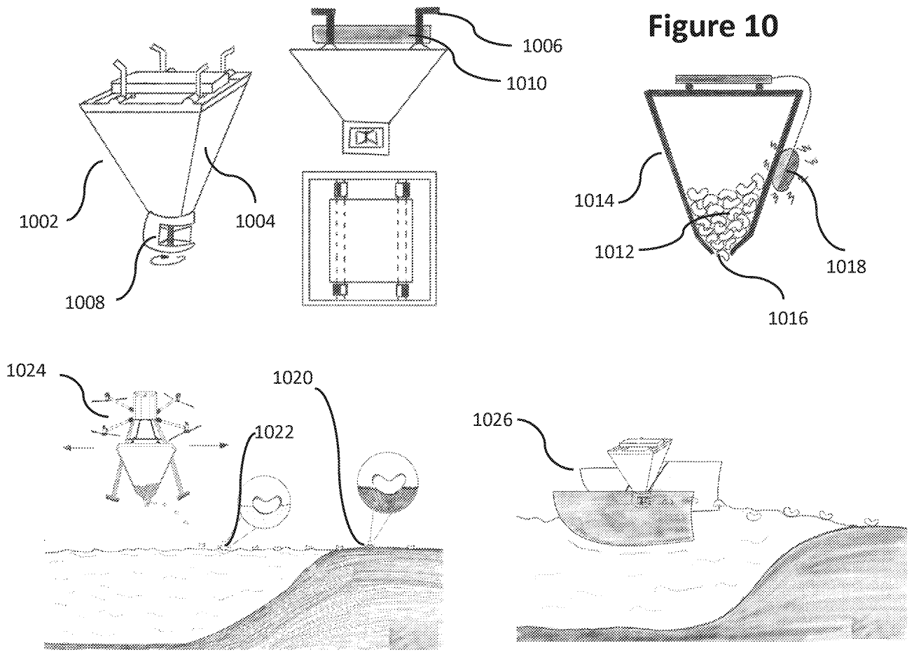

FIG. 10 is an illustration of an example of the Direct Seeding Subsystem Payload and use cases with the Aerial and Surface Mobile Platforms, in accordance with embodiments of the present invention. In some embodiments, the direct seeding subsystem payload (1002) can comprise a central storage compartment (1004), attachment hardware (1006) to mount to the mobile platform, electromechanical actuators (1008) to propel the seeds when appropriate, seed flow control systems, electronics and control systems (1010), and communication systems.

In some embodiments, the direct seeding subsystem payload can be designed to accommodate a variety of seed sizes, shapes, and types.

In some embodiments, the central storage compartment can be where the seeds (1012) are inserted and stored until they are distributed. In some embodiments, the size and volume of this compartment are limited by the specific mobile platform to which it is mounted. In some embodiments, the sides of the Direct Seeding Subsystem Payload can be angled (1014) to concentrate the seeds at the bottom and shaped to force the seeds into the drop chute (1016) at the bottom of the feeder system. In some embodiments, the bottom of the central storage compartment can have a ridge or conical shape to further force the seeds into the drop chute.

In some embodiments, the seeds can be loaded into the central storage compartment of the direct seeding subsystem payload and distributed according to the description of the payload and the mapping system generated distribution map.

In some embodiments, the drop chute (1016) can allow the seeds to drop with gravity directly onto the surface of the target destination.

In some embodiments, the drop chute can deliver the seed to an electromechanical actuator (1008) to propel the seeds away from the direct seeding subsystem payload and the mobile platform.

In at least one embodiment, the seeds can be distributed to the top of a soil or sediment environment (1020). In one embodiment, the seeds can be distributed to the top of a water environment (1022).

In at least one embodiment, the direct seeding subsystem payload can be connected to the aerial mobile platform (1024). In at least one embodiment, the direct seeding subsystem payload can be connected to the surface mobile platform (1026).

In at least one embodiment, a shaker actuator (1018) can be mounted to the side of the central storage compartment in order to dislodge the seeds. When the seeds are loaded into the central compartment, they stack on top of each other. The force of gravity and the friction between the seed surfaces will cause them to be locked into place and not move. The shaker provides a method to dislodge the seeds so that they can be moved through the system.

In some embodiments, once the seeds have separated from the delivery mechanism, gravity will be the main force. A parabolic arc will determine the final distance and location where the seeds are distributed onto the surface of the target destination.

### Seedball Subsystem Payload

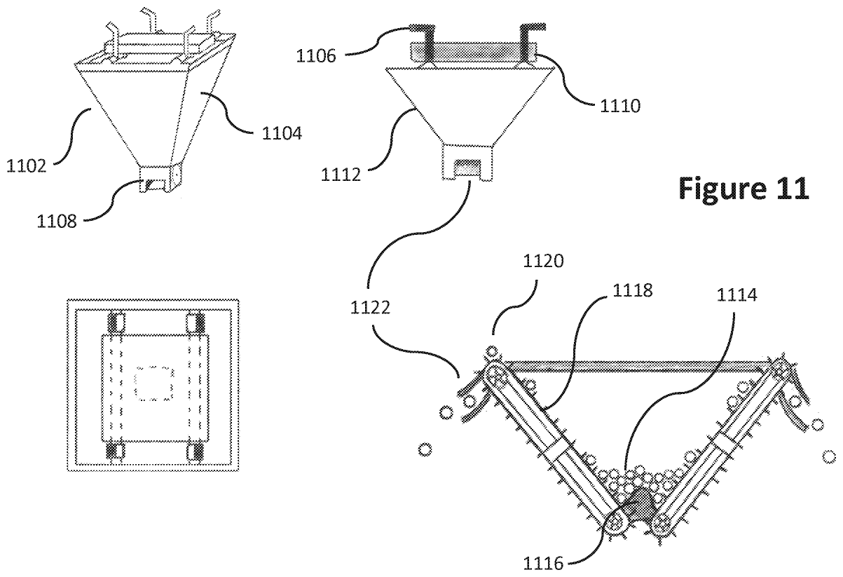

FIG. 11 is an illustration of an example of the Seedball Subsystem Payload and its components, in accordance with embodiments of the present invention.

In some embodiments, the Seedball Subsystem Payload (1102) can comprise a central storage compartment (1104), attachment hardware to mount to the mobile platform (1106), electromechanical actuators (1108) to release or propel the seedballs when appropriate, seedball flow control systems, electronics and control systems (1110), communication systems, a power source, a microprocessor, and pressurized containers for submersible and floor robotic mobile platforms.

In some embodiments, the seedball subsystem payload can be designed to accommodate a variety of seedball sizes.

In some embodiments, the Central Storage compartment of the Seedball Subsystem Payload can be where the seedballs (1114) are inserted and stored until they are distributed according to the description of the payload and the mapping system generated distribution map. In some embodiments, the size and volume of the central storage compartment can be varied by limitations by the specific mobile platform to which it is mounted. In some embodiments, the sides of the Seedball Subsystem Payload can be angled (1112) to concentrate the seedballs at the bottom and shaped to force the seedballs into the seedball feeder system. In some embodiments, the bottom of the central storage compartment can have a ridge or conical shape (1116) to further force the seedballs into the feeder system.

In some embodiments, the seedballs stored in the Seedball Subsystem Payload can be released and distributed according to the description of the payload and the mapping system generated distribution map.

In some embodiments, the Seedball Subsystem Payload can have a separation and Feeder System (1118). In some embodiments, the separation and feeder system can separate the individual seedballs from the central storage and deliver (1120) it to an electronic actuator such as a thrower, launcher, dropper (1122), or other mechanism, which can drop or propel the Seedball away from the Seedball Subsystem Payload and Mobile Platform.

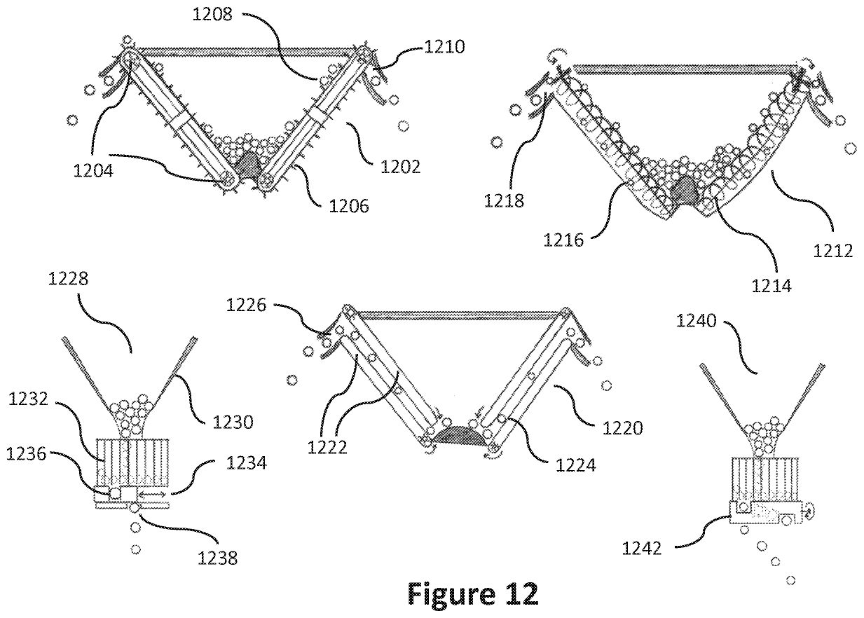

FIG. 12 is an illustration of an example of different seedball separation mechanisms for the Seedball Subsystem Payload, in accordance with embodiments of the present invention. In some embodiments, a number of types of internal components can be utilized to separate and carry the seedballs within the seedball subsystem payload. The seedball separation mechanisms are detailed as follows:

In some embodiments, a Lifting Belt (1202) can be used to separate and carry the seedballs. In some embodiments, the lifting belt can be comprised of two gears (1204), one of them actuated, and a belt with compartments (1206). In some embodiments, the compartment lifts a single seedball (1208). In some embodiments, the belt moves upwards and when the seedballs reach the edge, they can fall to the next stage (1210).

In some embodiments, a Helicoidal lift subsystem (1212) can be used to separate and carry the seedballs. In this embodiment, the helicoidal lift (1214) can be comprised of a cross shaped actuated rod and a helicoidal wire that wraps it. In this embodiment, with the rotation of the cross, the seedballs can move upwards following the path of the wire (1216), when they reach the edge (1218) they can be carried to the next stage.

In some embodiments, a Funnel Belt (1220) can be used to separate and carry the seedballs. In some embodiments, the funnel belt can consist of two parallel belts (1222) with an actuator for each belt that can pull the seedball (1224) upwards, when they reach the edge (1226), they can be carried to the next stage.

In some embodiments, a Pencil Box (1228) can be used to separate and carry the seedballs. In some embodiments, the pencil box can have three main parts, a funnel (1230) that piles the seedballs, a cage (1232), and a moving box (1234). In some embodiments, this moving box can contain a compartment where a single seedball fits (1236). In some embodiments, when moving horizontally the seedball can be separated and brought to a second hole (1238) placed in the bottom of the box where they can fall to the next stage.

In some embodiments, a Selector Wheel (1240) can be used to separate the seedballs. In some embodiments, the selector wheel can have the same properties as the pencil box but instead of a linear move it uses a rotative one (1242).

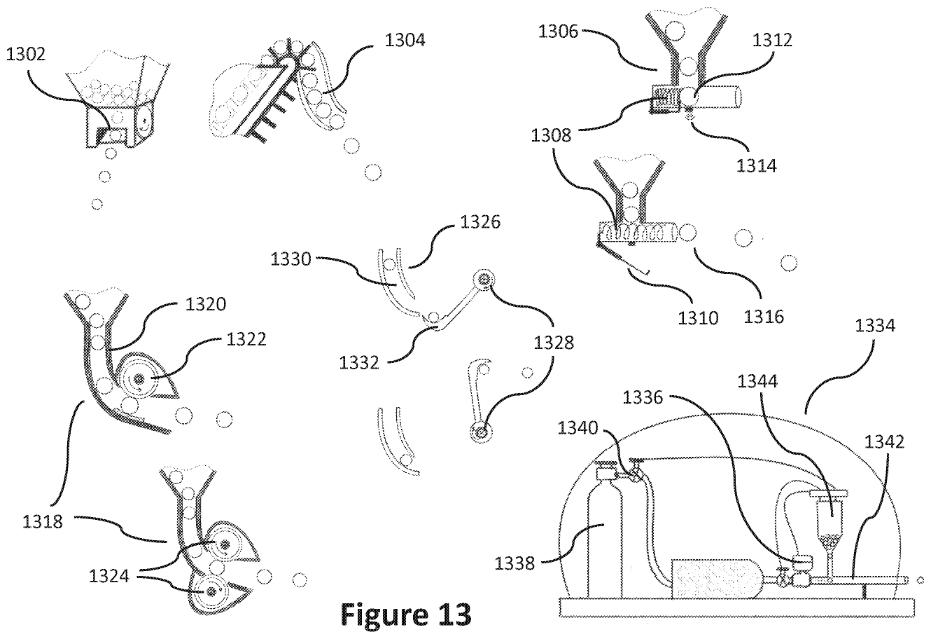

FIG. 13 is an illustration of an example of different seedball release mechanisms that allow the seedballs to be dropped by gravity or to have an induced velocity applied to the seedball to propel it away from the Seedball Subsystem Payload and Mobile Platform, in accordance with embodiments of the present invention. In some embodiments, the feeder mechanism can deposit one or more of the seedballs into a guide channel leading to a drop chute or actuator mechanism that applies an induced velocity to the seedball as described below:

In some embodiments, a Center Drop Chute (1302, or, e.g., as illustrated In FIG. 11, 1108) can be placed at the bottom of the central storage compartment and can allow one or more seedballs to drop out at the bottom at the designated drop rate.

In some embodiments, an Edge Drop guide (1304, or, e.g., as illustrated In FIG. 12, 1210, 1218, 1226) can be placed at the top of a feeder mechanism and can allow one or more seedballs to drop out at the top edge of the central storage compartment at the designated drop rate.

In some embodiments, a Thrower or Launcher can be used to induce a velocity and propel the seedball away from the Seedball Subsystem Payload and Mobile Platform, described as follows:

In some embodiments, a Spring-loaded shooter (1306) can be used to release a seedball with an induced velocity. In some embodiments, the Spring-loaded shooter (1306) can consist of compressing a spring (1308) and releasing the seedball with an initial velocity that accelerates the seedball. In some embodiments, a powered actuator (1310) can draw back the spring, allowing the seedball to drop into the chamber (1312), a sensor (1314) can detect when the seedball is ready for delivery, and can activate the actuator (1310) to release the spring to launch the seedball where gravity sends it into a parabolic arc (1316) until it lands at the designated location. In some embodiments, the total distance thrown can be modified by changing the compression strength of the spring, and/or compressing the spring tighter.

In some embodiments, a Rotational wheel launcher sub-system (1318) can be comprised of a channel (1320) that guides the seedball to one (1322) or two (1324) wheels that spin at a constant speed and shoot the seedballs. In some embodiments, the distance launched can be modified by changing the spinning speed of the wheels in order to induce a higher or lower departing velocity before gravity sends it into a parabolic arc until it lands at the designated location.

In some embodiments, a Catapult launcher subsystem (1326) can consist of a continuous rotating system (1328) that catapults the seedballs. In some embodiments, the channel (1330) can drop a seedball into the cradle of the catapult (1332), the spinner can cause a rotational arc of the catapult arm, and at the top of the arc, the seedball can separate from the catapult and gravity sends the seedball into a parabolic arc until the seedball lands at the designated location. In some embodiments, the catapult arm can be stopped after each launch in order to load and shoot a new seedball.

In some embodiments, a Pressurized/Compressed Gas launcher (1334) can be used to launch a seedball away from the mobile platform. In some embodiments, the Pressurized/Compressed Gas can comprise a firing control mechanism (1336) and an interchangeable pressurized/compressed gas canister (1338). In some embodiments, the Pressurize/Compressed Gas launcher subsystem can be equipped with a pneumatic firing apparatus which can comprise, in addition to the firing mechanism and the pressurized/compressed gas container, one or more gas regulators (1340), connecting hoses, chambers, a barrel (1342), and a connector to the central storage compartment (1344). In some embodiments, the gas regulators can vary the pressure to control the launching distance of the seedball from the subsystem payload and mobile platform. In some embodiments, the gas regulators can be adjusted manually. In some embodiments, the gas regulators can be adjusted by the electronic control system of the subsystem payload. In some embodiments, a trigger-controlled firing mechanism can release the pressurized/compressed gas in order to launch or propel the seedball out of the chamber and away from the Seedball Subsystem Payload and mobile platform.

In some embodiments, once the seedballs have separated from the Seedball Subsystem Payload, gravity will be the main force. A parabolic arc will determine the final distance and location that the seedballs are distributed.

In some embodiments, the seedball subsystem can include a shaker actuator (e.g., FIG. 10, 1018) to dislodge seedballs that have become trapped within the central storage compartment due to friction and gravity. In some embodiments, a shaker actuator can be mounted to the side of the central storage compartment in order to dislodge the seedballs. When the seedballs are loaded into the central compartment, they stack on top of each other. The force of gravity and the friction between the seedballs surfaces will cause them to be locked into place and not move. The shaker provides a method to dislodge the seedballs so that they can be moved through the system by the feeder mechanisms.

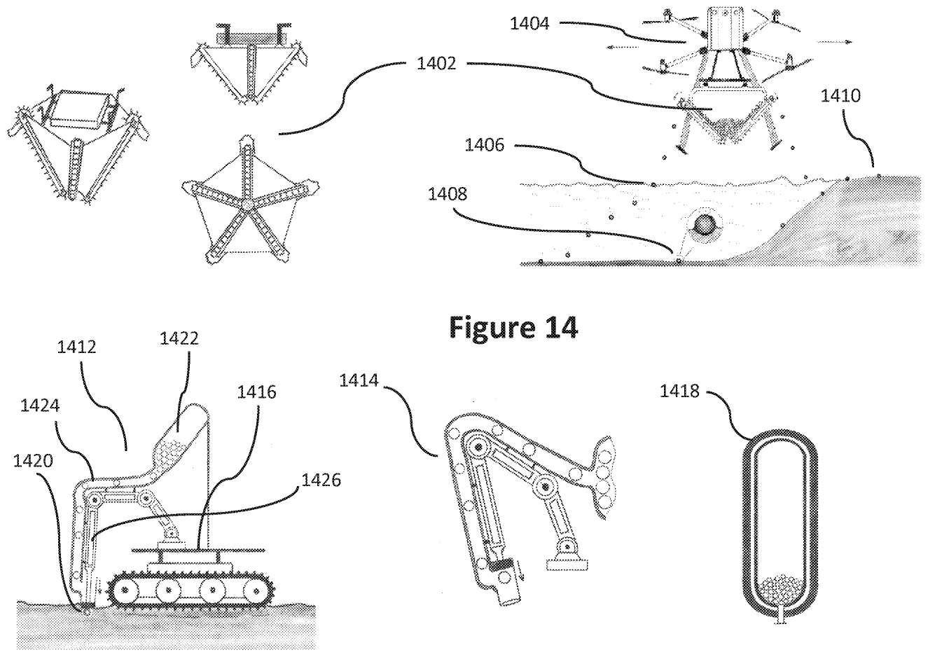

FIG. 14 is an illustration of an example of Seedball Subsystem Payloads when mounted to Aerial and Floor Robotic Mobile Platforms, in accordance with embodiments of the present invention. In some embodiments, the Seedball Subsystem Payload (1402) can be mounted to an Aerial Mobile Platform (1404) where the Seedball Subsystem Payload can release seedballs on the water surface (1406) to sink to the sediment floor (1408) or on the near-shore soil surface (1410). In some embodiments, the Seedball Subsystem Payload can be mounted to a Surface Mobile Platform (e.g., as illustrated in FIG. 7, 706, 712, 716). In Some embodiments, the Seedball Subsystem Platform can be mounted to a Submersible Mobile Platform e.g., as illustrated in (FIG. 8, 802). In some embodiments, the Seedball Subsystem Platform can be mounted to a Floor Robotic Mobile Platform (1412). In some embodiments, an electromechanical robotic arm (1414) can be mounted to the Submersible and Floor Robotic Mobile Platforms (1416) to aid in the distribution and placement of seedballs. In some embodiments, the central storage container can be a pressurized chamber (1418) or other design to keep the seedballs dry until distribution.

### Seed Puck Subsystem Payload

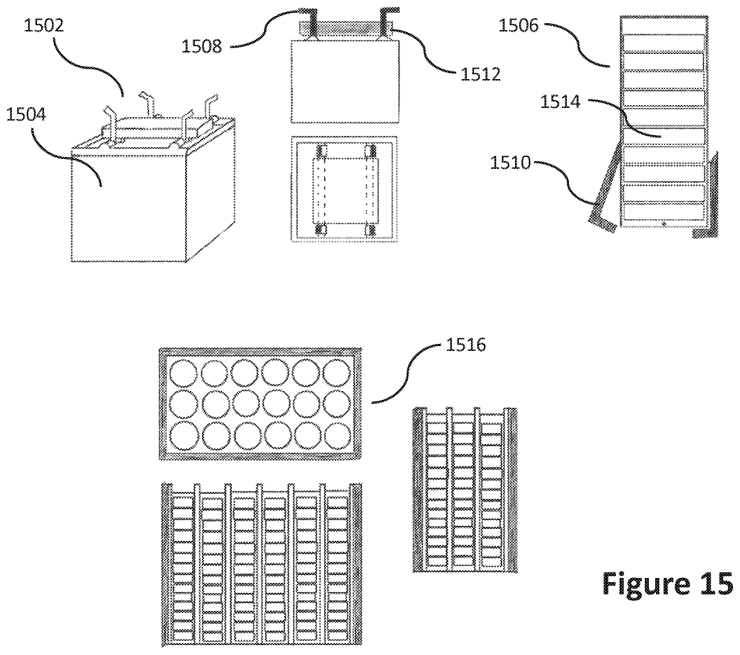

FIG. 15 is an illustration of an example of the Seed Puck Subsystem Payload and its components, in accordance with embodiments of the present invention.

In some embodiments, the Seed Puck Subsystem Payload (1502) can comprise a central storage compartment (1504), a set of cylindrical storage and dispensing tubes (1506), attachment hardware to mount to the mobile platform (1508), electromechanical actuators (1510) to release or propel the seed pucks when appropriate, electronics and control systems (1512), communication systems, a power source, a microprocessor, and pressurized containers for submersible and floor robotic mobile platforms.

In some embodiments, the seed puck subsystem payload can be designed to accommodate a variety of seed puck sizes.

In some embodiments, an internal cylindrical tube (1506) can be where the seed pucks (1514) are inserted and stored until they are distributed. In some embodiments, a tube can be designed to fit the specific diameter of the seed puck required for the seed size and target destination. In some embodiments, an internal sliding mechanism can vary to accommodate a range of diameters of seed pucks as described in the Seed Puck Organism Delivery Structure section. In some embodiments, the seed pucks can be stacked vertically into each of the tubes (1514). In some embodiments, an electronically controlled actuator (1510) can release each seed puck individually. In some embodiments, the tubes can be mounted in an X by Y configuration (1516). e.g., 3×3, 3×4, 4×6, or any configuration limited by the size, volume, and geometry of each specific mobile platform.

In some embodiments, the seed pucks stored in the Seed Puck Subsystem Payload can be released and distributed according to the description of the payload and the mapping system generated distribution map.

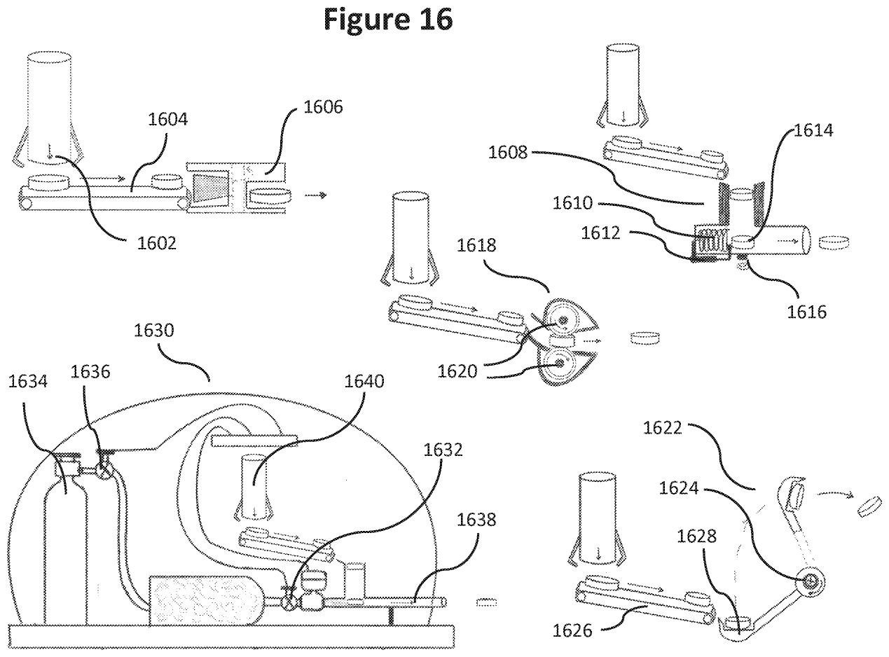

FIG. 16 is an illustration of an example of different seed puck release mechanisms that allow the seed puck to be dropped by gravity or to have an induced velocity applied to the seed puck to propel it away from the Seed Puck Subsystem Payload and Mobile Platform, in accordance with embodiments of the present invention. In some embodiments, the seed puck can be released from the tube (1602) and feed (1604) into a thrower or launcher (1606). In some embodiments, a thrower or launcher can be used to induce a velocity and propel the seed puck away from the Seed Puck Subsystem Payload and Mobile Platform, described below.

In some embodiments, a Spring-loaded shooter (1608) can be used to release a seed puck with an induced velocity. In some embodiments, the Spring-loaded shooter subsystem can consist of compressing a spring (1610) and releasing the seed puck with an initial velocity that accelerates the seed puck. In some embodiments, a powered actuator (1612) can draw back the spring, allowing the seed puck to drop into the chamber (1614), a sensor (1616) can detect when the seed puck is ready for distribution, and can activate the actuator to release the spring to launch the seed puck where gravity sends it into a parabolic arc until it lands at the designated location. In some embodiments, the total distance thrown can be modified by changing the compression strength of the spring, and/or compressing the spring tighter.

In some embodiments, a Rotational wheel launcher sub-system (1618) can be comprised of a guide feeder that guides the seed puck to one or more wheels (1620) that spin at a constant speed and shoot the seed puck. In some embodiments, the distance launched can be modified by changing the spinning speed of the wheels in order to induce a higher departing velocity before gravity sends the seed puck into a parabolic arc until it lands at the designated location.

In some embodiments, a Catapult launcher subsystem can consist of a continuous rotating system (1624) that catapults the seed puck. In some embodiments, the guide feeder (1626) can drop a seed puck into the cradle (1628) of the catapult, the spinner can cause a rotational arc of the catapult arm, and at the top of the arc, the seed puck separates from the catapult and gravity sends the seed puck into a parabolic arc until it lands at the designated location. In some embodiments, the catapult arm can be stopped after each launch in order to load and shoot a new seed puck.

In some embodiments, a Pressurized/Compressed Gas launcher (1630) can be used to launch a seed puck away from the mobile platform. In some embodiments, the Pressurized/Compressed Gas can comprise a firing control mechanism (1632) and an interchangeable pressurized/compressed gas canister (1634). In some embodiments, the Pressurized/Compressed Gas launcher subsystem can be equipped with a pneumatic firing apparatus which can comprise, in addition to the firing mechanism and the pressurized/compressed gas container, one or more gas regulators (1636), connecting hoses, chambers, a barrel (1638), and a connector to the central storage compartment (1640). In some embodiments, the gas regulators can vary the pressure to control the launching distance of the seed puck from the subsystem payload and mobile platform. In some embodiments, the gas regulators can be adjusted manually. In some embodiments, the gas regulators can be adjusted by the electronic control system of the subsystem payload. In some embodiments, a trigger-controlled firing mechanism can release the pressurized/compressed gas in order to launch or propel the seed puck out of the chamber and away from the Seed Puck Subsystem Payload and mobile platform.

In some embodiments, once the seed pucks have separated from the Seed Puck Subsystem Payload, gravity will be the main force. A parabolic arc will determine the final distance and location where the seed pucks are distributed.

In some embodiments, the tubes can be pressurized to keep the seed pucks dry until delivery.

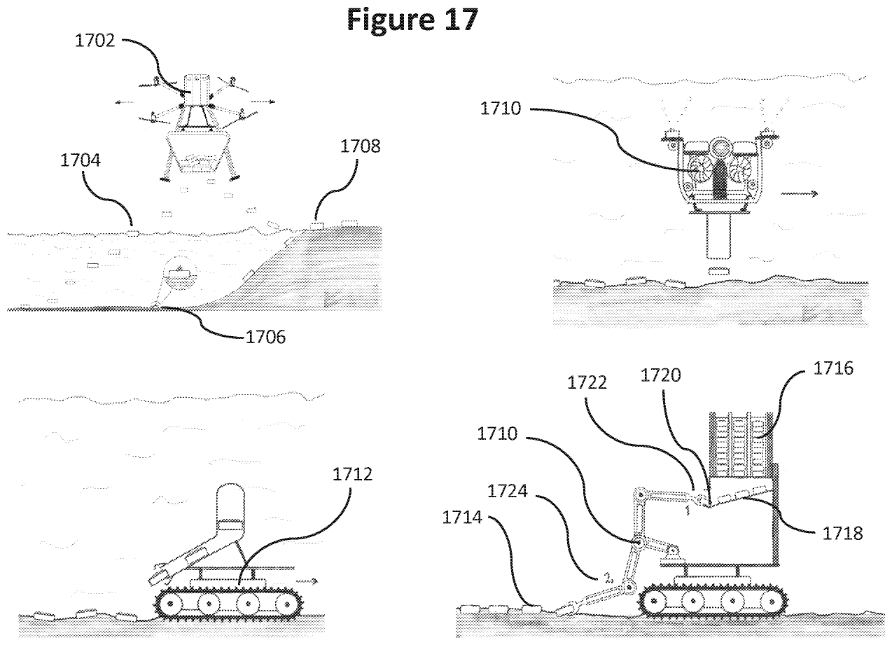

FIG. 17 is an illustration of an example of Seed Puck Subsystem Payloads when mounted to Aerial, Submersible, and Floor Robotic Mobile Platforms, in accordance with embodiments of the present invention. In some embodiments, the Seed Puck Subsystem Payload (1502) can be mounted to an Aerial Mobile Platform (1702) where it can release Seed Puck Organism Delivery Structures on the water surface (1704) to sink to the sediment floor (1706) or on the near-shore soil surface (1708). In some embodiments, the Seed Puck Subsystem Payload can be mounted to a Surface Mobile Platform. In some embodiments, the Seed Puck Subsystem Payload can be mounted to a Submersible Mobile Platform (1710). In some embodiments, the Seed Puck Subsystem Payload can be mounted to the Floor Robotic Mobile Platform (1712). In some embodiments, an electromechanical robotic arm (1714) may be mounted to the Submersible and Floor Robotic Mobile Platforms to aid in the delivery and placement of seed pucks. In some embodiments, the central storage container can be a pressurized chamber or other design to keep the seed pucks dry until delivery.

### Seedling Cones Subsystem Payload

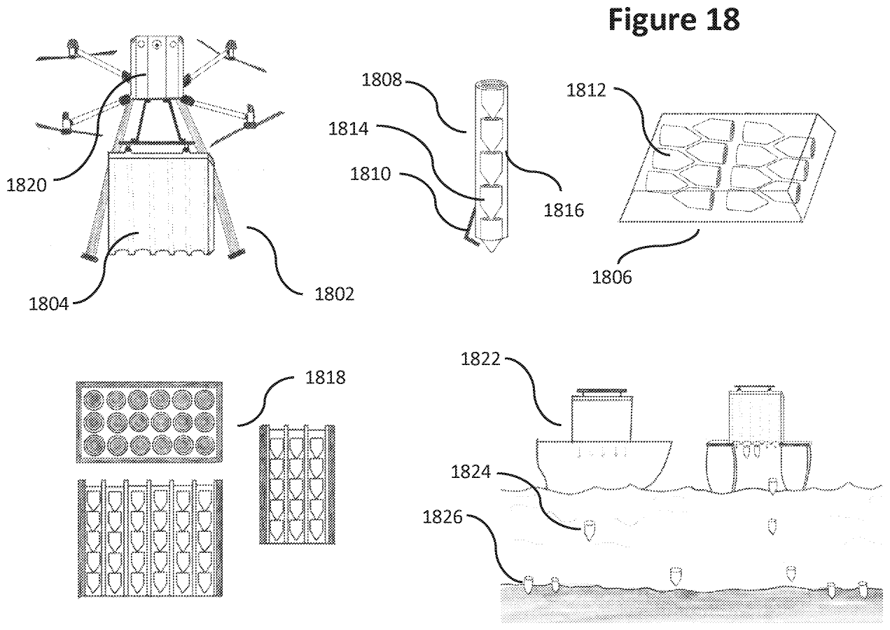

FIG. 18 is an illustration of an example of the Seedling Cone Subsystem Payload and its components with a cylindrical tube and try based storage and dispensing system, in accordance with embodiments of the present invention.

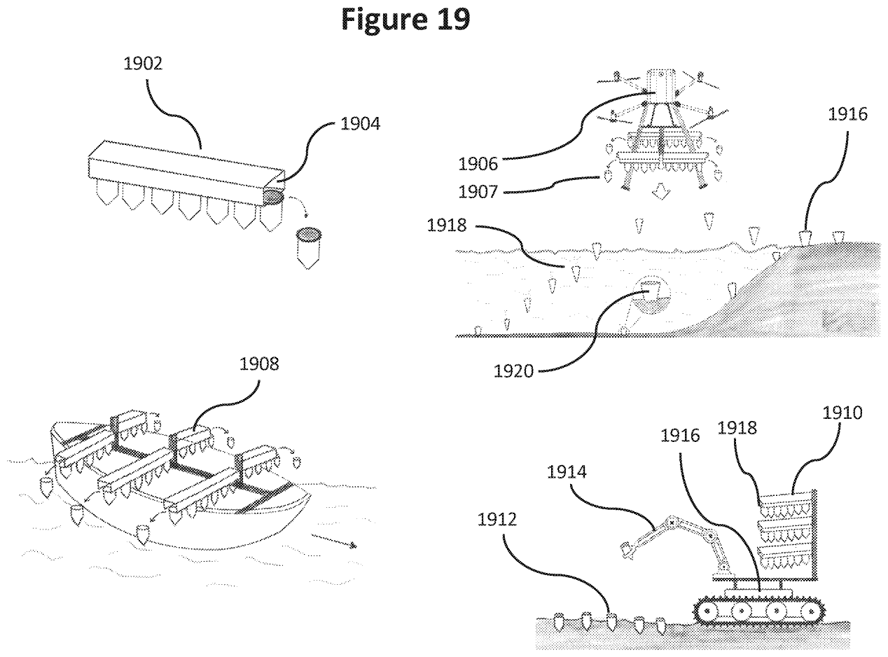

In some embodiments, the Seedling Cone Subsystem Payload (1802) can comprise a central storage compartment (1804), storage trays (1806) or cylindrical tubes (1808), electromechanical actuators (1810) to release or propel the seedling cones when appropriate, electronics and control systems, communication systems, a power source, a microprocessor, and pressurized containers for submersible and floor robotic mobile platforms. In some embodiments, the Seedling Cone Subsystem Payload can be mounted on any of the mobile platforms as shown in examples (1820, 1822, or, e.g., as illustrated In FIG. 19, 1906, 1908, 1910) as described, with modification specific to that mobile platform. In some embodiments, the seedling cones can be inserted into the dispensing containers within the storage trays (1812) or the cylindrical tubes (1814). In some embodiments, the dispensing containers can be mounted on any of the mobile platforms as described, with modifications specifically to that mobile platform. In some embodiments, the dispensing containers can include internal supporting racks, trays, or cylindrical tubes for stacking nested seedling cones within the dispensing container for transport and for discharge at an open end thereof. In some embodiments, the individual seedling cones can be pushed from the dispensing containers at a rate depending upon the velocity of the mobile platform, altitude, and planting density required for the target destination.

In some embodiments, a tube can be designed to fit the specific diameter of the seedling cone required for the seed or seedling and target destination. In some embodiments, an internal sliding mechanism can vary to accommodate a rage of diameters of seedling cones. In some embodiments, the seedling cones can be stacked vertically (1816) into each of the cylindrical tubes. In some embodiments, an electronically controlled actuator (1810) can release each seedling cone individually. In all embodiments, the cylindrical tubes can be mounted in an X by Y configuration (1818). e.g., 3×3, 3×4, 4×6 or any configuration limited by the size, volume, and geometry of each specific mobile platform. In some embodiments, the seedling cones subsystem payload can be utilized in any of the mobile platforms, as shown for the Aerial (1820), Surface (1822), and Floor Robotic Mobile Platforms, as described with modification specific to that mobile platform. In some embodiments, the cones can fall or descend with gravity through the air and/or liquid (1824) environment until they land in the target location (1826).

FIG. 19 is an illustration of an example of the Seedling Cone Subsystem Payload and its components with a magazine-based storage and dispensing system, in accordance with the present invention. In some embodiments, the seedling cones can be mounted in a spring-loaded magazine (1902). In some embodiments, the magazine has an internal sliding mechanism to advance the Seedling cone to the edge of the magazine (1904). In some embodiments the magazine can be connected to an electronic actuator, piston, or pusher which can dispense one or more of the seedling cones when the mobile platform reaches the target destination. In some embodiments, the seedling cones subsystem payload can be utilized in any of the mobile platforms, as shown for the Aerial (1906, or, e.g., as illustrated In FIG. 18, 1820), Surface (1908, or, e.g., as illustrated In FIG. 18, 1822), and Floor Robotic (1910) Mobile Platforms, as described with modification specific to that mobile platform.

In some embodiments, the seedling cones stored in the Seedling Cone Subsystem Payload can be released and distributed according to the description of the payload and the mapping system generated distribution map. In some embodiments, the cones can fall or descend with gravity through the air and/or liquid (e.g., as illustrated In FIG. 18, 1824) environment until they land in the target location (e.g., as illustrated In FIG. 18, 1826). In some embodiments, the cones can be planted (1912) with an electromechanical robotic arm (1914) mounted to the submersible and/or floor robotic mobile platform.

In some embodiments, an electromechanical robotic arm can be mounted to the submersible or floor robotic system (1914) or directly to the seedling cone payload that can take a seedling cone from the seedling cone payload dispenser or magazine and insert it into the subsurface sediment.

In some embodiments, when dispensed from the aerial mobile platform, the seedling cones can form a projectile (1907). In some embodiments, the seedling cones can land onto a near-shore soil surface (1916). In some embodiments, the seedling cones can fall onto a water surface to sink (1918) to the sediment floor (1920). In some embodiments, the tray storage dispenser can have the cones alternated to optimize the fit and the number of seedling cones in each tray (e.g., as illustrated in FIG. 18, 1812). In some embodiments, the dispensing trays can be stacked vertically and mounted in rows within the dispensing container. In some embodiments, the distribution pattern of the seedling cones can be modified to accommodate the altitude and velocity of the aerial mobile platform and the rate of distribution. In some embodiments, the dispensing trays can have a quick removal latch so that a quick change of spent trays with loaded trays can be made in the field. In some embodiments, the trays can be loaded with the seedling cones prior to shipment to the field and can be reloaded in the field. In some embodiments, the trays can be horizontally supported, and a pusher or actuator can be a pneumatic, electric, or air driven device to push the seedling cones out of the trays. In some embodiments, the trays can be vertically inserted, and an electronically controlled actuator can release the seedling cones out the bottom with a gravity assist.

In some embodiments, the Central storage and dispensing unit and trays may be molded plastic sheet material, vacuum formed plastic, formed sheet metal or other metal forms. In some embodiments, the trays can have slide-in support structures and latches to hold them in place. In some embodiments, the trays can have at least a bottom half and may have a top support structure connected with a hinge or a connecting wire. In some embodiments, an internal pusher can be built into each level of the tray with a guide system to allow uniform force to be applied to push out each of the seedling cones. In some embodiments, specific interfaces can be provided to retain the seedling cones until the actuator releases or pushes it out of the tray.

### Drop Bag Subsystem Payload:

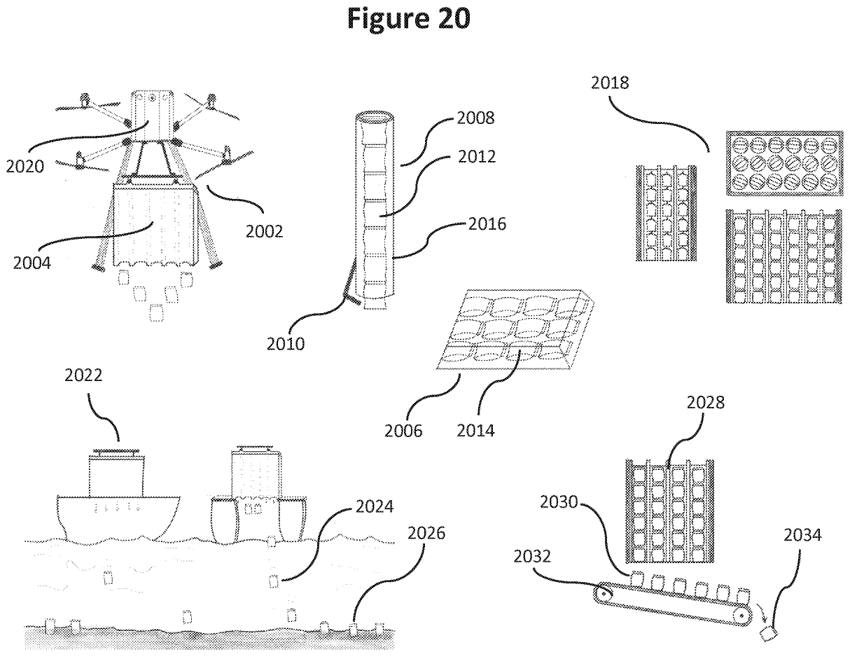

FIG. 20 is an illustration of an example of the Drop Bag Subsystem Payload and its components with a cylindrical tube and tray-based storage and dispensing system, in accordance with embodiments of the present invention. In some embodiments, the drop bag subsystem payload can be used with the aerial, surface, and submersible mobile platforms.

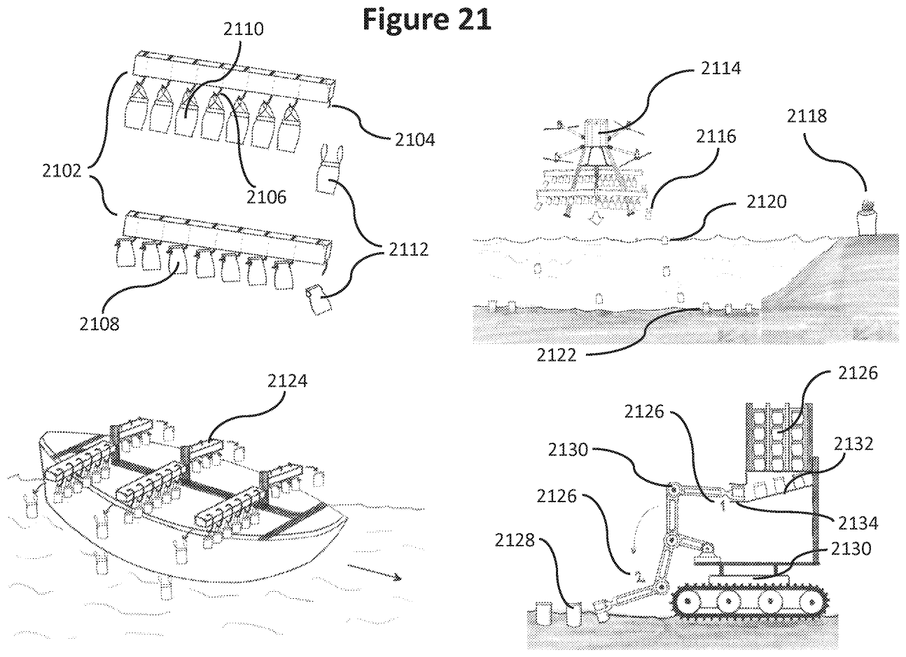

In some embodiments, the Drop Bag Subsystem Payload (2002) may comprise a central storage compartment (2004), storage trays (2006) or cylindrical tubes (2008), electro-mechanical actuators (2010) to release or propel the Drop Bag Organism Delivery Structure when appropriate, electronics and control systems, communication systems, a power source, a microprocessor, and pressurized containers for the submersible and floor robotic mobile platforms. In some embodiments, the Drop Bag Subsystem Payload can be mounted on any of the mobile platforms as shown for the Aerial (2020, or, e.g., as illustrated In FIG. 21, 2114), Surface (2022, or, e.g., as illustrated In FIG. 21, 2124), and Floor Robotic (e.g., as illustrated In FIG. 12, 2126) Mobile Platforms as described, with modifications specific to that mobile platform. In some embodiments, the drop bags can be inserted into the dispensing containers within the storage trays (2012) or the cylindrical tubes (2014). In some embodiments, the dispensing containers can include internal supporting racks, trays, or cylindrical tubes for stacking nested drop bags within the dispensing container for transport and for discharge at an open end thereof. In some embodiments, the individual drop bags can be pushed from the dispensing containers at a rate depending upon the velocity of the mobile platform, altitude, and planting density required for the target destination.

In some embodiments, a cylindrical tube can vary to fit the specific size of the drop bag required for the seed and target destination. In some embodiments, an internal sliding mechanism can vary to accommodate a range of diameters of drop bags. In some embodiments, the drop bags can be stacked vertically (2016) into each of the cylindrical tubes. In some embodiments, an electronically controlled actuator (2010) can release each drop bag individually. In some embodiments, the cylindrical tubes can be mounted in an X by Y configuration (2018). e.g., 3×3, 3×4, 4×6 or any configuration limited by the size, volume, and geometry of each specific mobile platform. In some embodiments, the dispensing container (2028) can release the drop bags (2030) onto a mechanical belt feeder (2032) which will deliver the drop bags to a drop chute or off the side of the mobile platform (2034).

FIG. 21 is an illustration of an example of the Drop Bag Subsystem Payload and its components with a magazine-based storage and dispensing system, in accordance with the present invention. In some embodiments, the magazine (2102) can have an internal sliding mechanism to advance the Drop Bag Organism Delivery Structure to the edge of the magazine (2104). In some embodiments, the magazine can have a rotational belt to advance the Drop Bag to the edge of the magazine. In some embodiments, the magazine sliding mechanism or rotational belt can have an actuated hook or latch (2106). In some embodiments the drop bags with a ring (2108) or strap (2110) can be mounted to a hook or latch on the magazine that can be activated electronically to release the drop bag (2112) at the outer edge when the mobile platform has reached the target destination. In some embodiments, the magazine-based Drop Bag Subsystem Payload can be mounted to any mobile platform as show for the aerial (2114, or, e.g., as illustrated In FIG. 20, 2020), surface (2116, or, e.g., as illustrated In FIG. 20, 2022), and floor robotic (2118) mobile platforms.

In some embodiments, the drop bags can fall or descend with gravity through the air (2116) and/or liquid (2120, or, e.g., as illustrated In FIG. 20, 2024) environment until the drop bags land in the target destination (2026). In some embodiments, the drop bags can be planted (2128) with an electromechanical robotic arm (2130) mounted to the submersible or floor robotic mobile platform.

In some embodiment, an electromechanical robotic arm can be mounted to the submersible or floor robotic mobile platforms or directly to the drop bag payload that can take a drop bag from the drop bag payload dispenser or magazine and insert it into or onto the subsurface sediment.

In some embodiments, when dispensed from the aerial mobile platform, the drop bags can form a projectile (2116). In some embodiments, the drop bags can land onto a near-shore soil surface (2118). In some embodiments, the drop bags can fall onto a water surface (2120) and can sink to the sediment floor (2122). In some embodiments, the drop bags can be stacked and oriented to optimize the fit and the number of drop bags in each tray. In some embodiments, the dispensing trays can be stacked vertically and mounted in rows within the dispensing container. In some embodiments, the distribution pattern of the drop bags can be modified to accommodate the altitude and velocity of the aerial mobile platform and the rate of distribution. In some embodiments, the dispensing trays can have a quick removal latch so that a quick change of spent trays with loaded trays can be made in the field. In some embodiments, the trays can be loaded with the drop bags prior to shipment to the field and can be reloaded in the field. In some embodiments, the trays can be horizontally supported and a pusher or actuator can be a pneumatic, electric, or air driven device to push the drop bags out of the trays. In some embodiments, the trays can be vertically inserted and an electronically controlled actuator can release the drop bags out the bottom with a gravity assist. In some embodiments, the drop bags can be hung from a number of magazines and individually released by an electronically controlled actuator or latch. In some embodiments, the drop bags can be placed on a rotational belt which rotates at each specific drop location allowing one or more drop bags to rotate off and fall to the destination surface.

In some embodiments, the Central storage and dispensing unit and trays, tubes, magazines, and other components of the drop bag subsystem payload may be molded plastic sheet material, vacuum formed plastic, formed sheet metal, or other metal forms. In some embodiments, the trays can have slide-in support structures and latches to hold them in place. In some embodiments, the trays can have at least a bottom half and may have a top support structure connected with a hinge or a connecting wire. In some embodiments, an internal pusher can be built into each level of the tray with a guide system to allow uniform force is applied to push out each of the drop bags. In some embodiments, specific interfaces can be provided to retain the drop bags until the actuator releases or pushes it out of the tray.

### Deployable Mats Subsystem Payload:

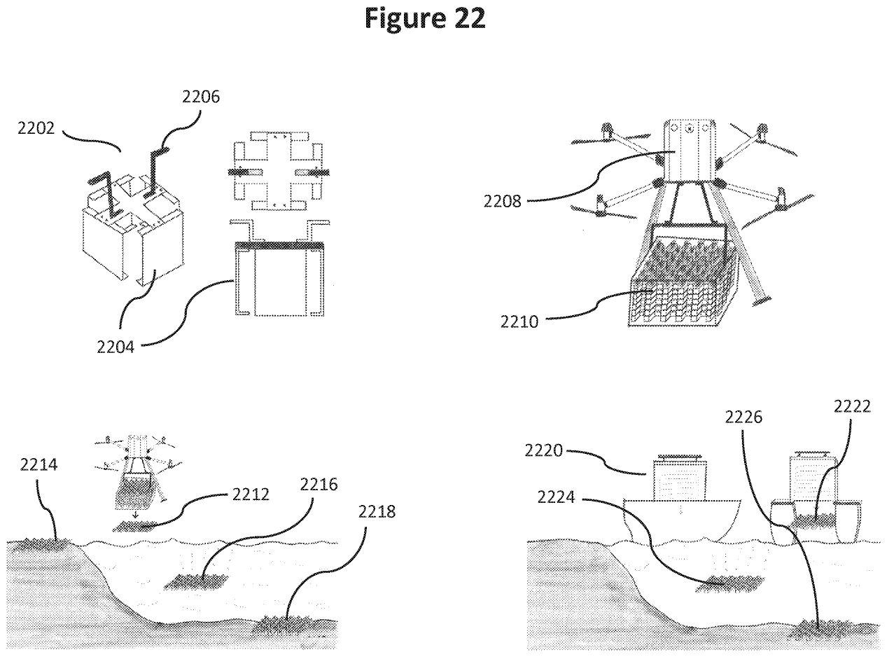

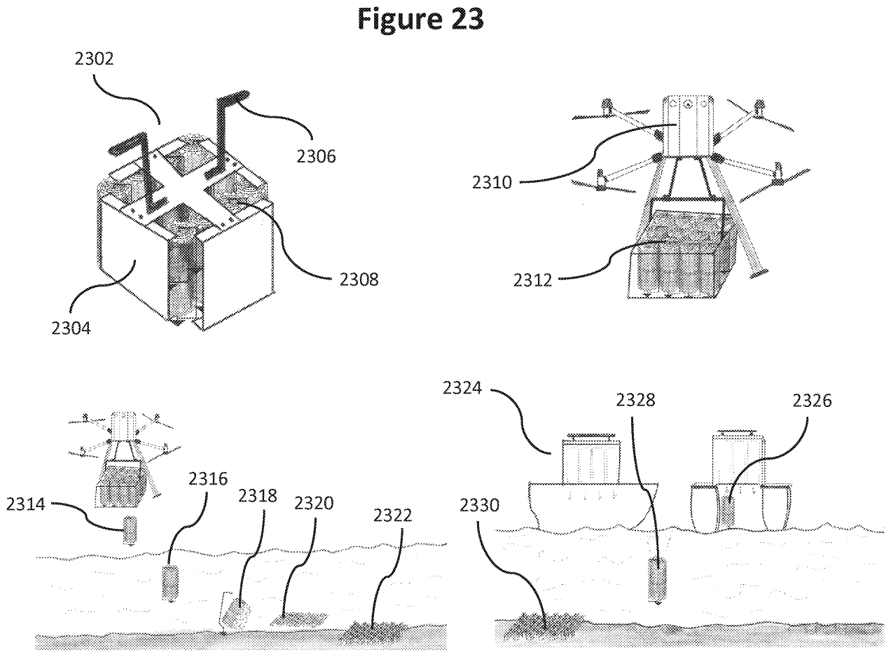

FIG. 22 is an illustration of an example of the Deployable Mat Subsystem Payload and its components with a flat, extended Deployable Mat, in accordance with the present invention. FIG. 23 is an illustration of an example of the Deployable Mat Subsystem Payload and its components with a rolled Deployable Mat, in accordance with the present invention. In some embodiments, the Deployable Mat Subsystem Payload (2202, 2302) can comprise a series of mechanical support brackets (2204, 2304), attachment hardware (2206, 2306) to mount to the mobile platform, and electromechanical actuators to release the deployable mats when the mobile platform reaches the target destination. In some embodiments, the Deployable Mats Subsystem Payload can be utilized with the aerial (2208, 2310) and surface (2220, 2324) mobile platforms.

In some embodiments, the Deployable Mat Organism Delivery Structure can be stored in the Deployable Mat Subsystem Payload in an extended, flat configuration (2210). In some embodiments, the Deployable Mats can be stored in the Deployable Mat Subsystem Payload in a rolled (2312) configuration.

In at least one embodiment, one or more flat, extended mats are stacked vertically (2210). In some embodiments, an individual release mechanism can release the flat, extended Deployable Mat one at a time (2212, 2222). In at least one embodiment, one or more mats in a rolled configuration can be suspended within the mounting bracket (2308) of the Deployable Mat Subsystem Payload. In some embodiments, an individual release mechanism can release the rolled Deployable Mat one at a time (2314).

In some embodiments, the rolled mats are mounted within the mounting bracket of the Deployable Mat Subsystem Payload in an X by Y configuration (2312) e.g., 3×3, 3×4, 4×6, or any configuration limited by the geometry of each specific mobile platform.

In some embodiments, the flat, extended Deployable Mat can be released to fall or descend with gravity through the air (2212) onto a near-shore soil surface (2214). In some embodiments, the flat, extended Deployable Mat can be released over a water surface (2212, 2222) and sink (2216, 2224) to the sediment floor (2218, 2226). In some embodiments, the rolled Deployable Mat can be released to fall or descend with gravity through the air (2314). In some embodiments, the rolled Deployable Mat can be released over a water surface (2314, 2326) and sink (2316, 2328) to the sediment floor which can trigger the release mechanism (2318), to allow the rolled Deployable Mat to open into the flat, extended configuration (2320) on the sediment surface (2322, 2330).

### Electromechanical Robotic Arm:

### General

In some environments, there are areas requiring restoration that are exposed to higher tidal flow rates at both the surface and subsurface. In these conditions, it will be advantageous to insert the organism delivery structure into the sediment or soil of the target destination in order to ensure they are stable and secure. In some embodiments, an electromechanical robotic arm (e.g., as illustrated In FIG. 14, 1414; FIG. 17, 1710; FIG. 19, 1914; and FIG. 21, 2130) can be provided to transfer the organism delivery structure from the subsystem payload and mobile platform to the sediment or soil of the target destination (e.g., as illustrated In FIG. 14, 1420; FIG. 17, 1714; FIG. 19, 1912; and FIG. 21, 2128; and further discussed below). In some embodiments, the electromechanical robotic arm can be an electromechanical structure that can be mounted to the mobile platform or the subsystem payload. In some embodiments, the electromechanical robotic arm can comprise on-board power, control systems, and guidance to operate the electromechanical robotic arm and deliver the organisms to the preselected location. In some embodiments, the form and detailed design of the electromechanical robotic arm can be varied for the specific organism delivery structure, the mobile platform, and the subsystem payload, as presented in the following sections. In at least one embodiment, one or more electromechanical robotic arms can be mounted to the submersible mobile platform. In at least one embodiment, one or more electromechanical robotic arms can be mounted to the floor robotic mobile platform.

In some embodiments, the electromechanical robotic arm may also include a visual sensor and a light to enable the robot to see the condition of the target destination. In some embodiments, each joint of the electromechanical robotic arm can include drive systems that may be driven by at least one electric, pneumatic, or hydraulic motor or other method such as pneumatic muscles. In some embodiments, the motors can either be servos, stepper motors or any motor with position feedback such as encoders. In some embodiments, the “arms” can further comprise “arm upper linkage” and “arm lower linkage” elements coupled at an “elbow” element. In some embodiments, the arms may comprise “arm motors” at any location as long as the motor can be capable of moving the arm at the desired joint.

### Electromechanical Robotic Arm for the Placement of Seedballs:

FIG. 14 further illustrates the placement of seedballs with an electromechanical robotic arm. In at least one embodiment, one or more electromechanical robotic arms can be mounted to the seedball subsystem payload or mobile platform, such as the floor robotic mobile platform (1412).

In some embodiments, the seedballs can be directed from the central storage compartment (1422) of the seedball subsystem payload by a feeder system into an enclosed channel (1424) that follows the length of the electromechanical robotic arm. In at least one embodiment, at the end of the electromechanical robotic arm, the seedball can drop out directly onto the surface.

In at least one embodiment, the seedball can exit the channel at the end of the electromechanical robotic arm into a chamber which is open at the bottom and with a pusher actuator at the top (1426). In some embodiments, the pusher can be electronically controlled by the electronic control system and activated to push the seedball out of the chamber into the sediment or soil (1420) at the target destination. In at least one embodiment, an electronically controlled piston actuator can be used to push the seedball out of the chamber into the sediment or soil at the target destination.

In some embodiments, the mobile platform can follow a predetermined path. In some embodiments, the system can slow and/or stop at each programmed location and allow the electromechanical robotic arm to place one or more seedballs.

### Electromechanical Robotic Arm for the Placement of Seed Pucks:

FIG. 17 further illustrates the placement of Seed Pucks with an electromechanical robotic arm. In at least one embodiment, one or more electromechanical robotic arms can be mounted to the seed puck subsystem payload or mobile platform, such as the floor robotic mobile platform (1712).

In some embodiments, the seed pucks can be directed from the storage cylindrical tube (1716) of the seed puck subsystem payload by a feeder system (1718) into a retrieval slot (1720). In some embodiments, the retrieval slot can orient the seed puck so that it can be picked up by the electromechanical robotic arm at position 1 (1722). In some embodiments, the electromechanical robotic arm, when the robotic arm is used for the distribution of seed puck organism delivery structures, can have an electronically controlled gripper or latching system which can pick up an individual seed puck from the retrieval slot. In some embodiments, the electromechanical robotic arm can then move into position 2 (1724) and can place the tip of the seed puck into the sediment or soil of the target destination and then gently push the seed puck into the sediment or soil until the seed puck is firmly set.

In some embodiments, the mobile platform can follow a predetermined path. In some embodiments, the mobile platform can slow and/or stop at each programmed location from the generated distribution map and can allow the electromechanical robotic arm to place one or more seed pucks.

### Electromechanical Robotic Arm for the Placement of Seedling Cones:

FIG. 19 further illustrates the placement of seedling cones with an electromechanical robotic arm. In at least one embodiment, one or more electromechanical robotic arms (1914) can be mounted to the seedling cone subsystem payload or mobile platform, such as the floor robotic mobile platform (1916).

In some embodiments, the seedling cones will be directed from the central storage compartment (1910) of the seedling cone subsystem payload by a feeder system into a retrieval slot (1918). In some embodiments, the retrieval slot (1918) can orient the seedling cone so that it can be picked up by the electromechanical robotic arm. In some embodiments, the electromechanical robotic arm, when the robotic arm is used for the distribution of seedling cone organism delivery structures, can have an electronically controlled gripper or latching system which can pick up an individual seedling cone from the retrieval slot. In some embodiments, the electromechanical robotic arm can then move into position to allow the placement of the tip of the seedling cone into the sediment or soil of the target destination and then gently push the seedling cone into the sediment or soil until the seedling cone is firmly set.

In some embodiment, the mobile platform can follow a predetermined path. In some embodiments, the mobile platform can slow and/or stop at each programmed location from the generated distribution map and can allow the electromechanical robotic arm to place one or more seedling cones.

### Electromechanical Robotic Arm for the Placement of Drop Bags:

FIG. 21 further illustrates the placement of Drop Bags with an electromechanical robotic arm. In at least one embodiment, one or more electromechanical robotic arms can be mounted to the drop bag subsystem payload or mobile platform, such as the floor robotic mobile platform (2130)

In some embodiments, the drop bags can be directed from the central storage compartment (2126) of the drop bag subsystem payload by a feeder system (2132) into a retrieval slot (2134). In some embodiments, the retrieval slot can orient the drop bag so that the drop bag can be picked up by the electromechanical robotic arm at position 1 (2126). In some embodiments, the electromechanical robotic arm when it is used for the delivery of drop bag organism delivery structures, can have an electronically controlled gripper or latching system which can pick up an individual drop bag from the retrieval slot. In some embodiments, the electromechanical robotic arm can then move into position 2 (2126) and can place the drop bag on the surface of the sediment or soil of the target destination and then gently push the drop bag into the sediment or soil until the drop bag is firmly set. In some embodiments, the mobile platform can follow a predetermined path. In some embodiments, the mobile platform can slow and/or stop at each programmed location from the generated distribution map and can allow the robotic extension arm to place one or more drop bags.

### Surface Docking and Take-Off and Landing Platform

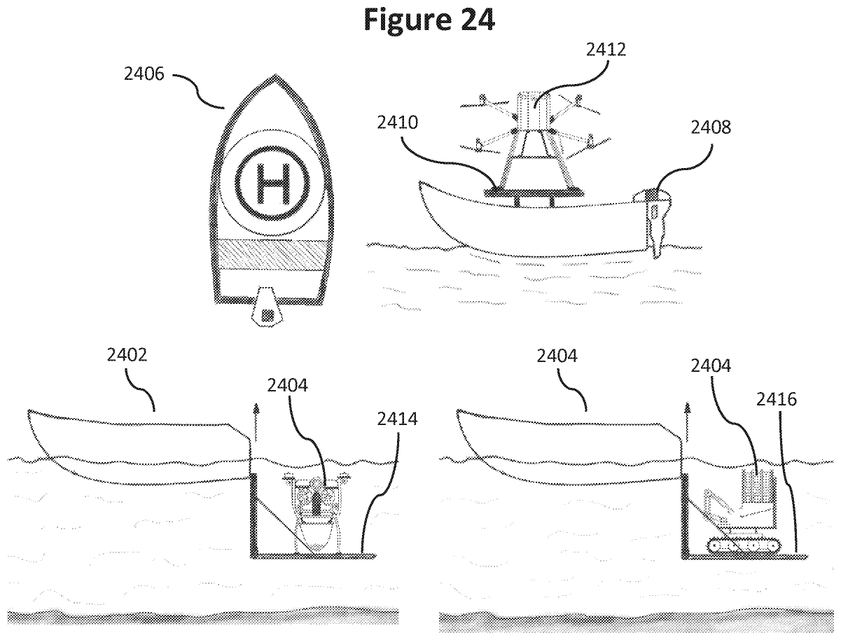

FIG. 24 is an illustration of an example of the Surface Docking and the Take-off and Landing Platforms for retrieval of the Aerial, Submersible, and Floor Robotic Mobile Platforms and their components, in accordance with embodiments of the present invention.

In some embodiments, the Surface Docking (2402, 2404) and the Take-off and Landing (2406) Platforms have a positive buoyancy to remain on the water surface. In some embodiments, the Surface Docking and the Take-off and Landing Platforms can be an automated, autonomous system. In some embodiments, the Surface Docking and the Take-off and Landing Platforms can be a manned system. In some embodiments the Surface Docking and the Take-off and Landing Platforms can be tethered to another mobile or stationary system.

In at least one embodiment, the surface docking and the take-off and landing platforms can be a manned boat or other type of vehicle that maintains a positive buoyancy on a water surface. In some embodiments, the surface docking and the landing platforms can be a remote controlled, unmanned water vehicle.

In some embodiments, the surface docking and the take-off and landing platforms can be an autonomous, unmanned water vehicle. In at least one embodiment, the surface docking and the take-off and landing platforms can be a stationary system that is anchored in place.

In at least one embodiment, the surface docking and the take-off and landing platforms can include a propulsion component (2408) suitable for aquatic movement of the device. In at least one embodiment, the propulsion component can comprise a propeller. In at least one embodiment, the propulsion component can comprise a pump-jet, impeller, or other mechanism for propulsion. In some embodiments, the propulsion component may further comprise one or more steering mechanisms, such as rudders, hydroplanes, ballast tanks, and so forth.

In at least one embodiment, the surface docking and the take-off and landing platforms can include a battery, fuel tank, or other means of storing or generating energy for the operation of the platform components and mobile platforms docking to or landing on these surface-based systems. In at least one embodiment, the surface docking and the take-off and landing platforms can include connection hardware to attach to the mobile platforms docking with or landing on this surface platform.

In at least one embodiment, the surface docking and the take-off and landing platforms can include electronics control systems for operation of the mobile platform, command and control of subsystems payloads, communication with other components of the integrated system, and guidance.

In at least one embodiment, the surface docking and the take-off and landing platforms can have on-board power, control systems, and guidance. In at least one embodiment, the surface docking and the take-off and landing platforms can have charging equipment to recharge docked and landed mobile platforms.

In at least one embodiment, a plurality of sensors can be mounted or tethered to the surface docking and the take-off and landing platforms in order to map and record a number of features. In some embodiments, sensors can include visual, infrared, near-infrared, Light Detection and Radar (LiDAR), Radar, side-scan radar, temperature, salinity, total dissolved solids, compound specific sensors, carbon content of biomass, carbon content of the soils and sediments, other sensors, and/or a combination therein. In some embodiments, features that can be recorded and mapped can include, but are not limited to, topology, vegetative coverage, biodiversity, soil types, water flow rates and direction, temperature, salinity, oxygen content, presence of toxic compounds, other features, and/or a combination therein.

In some embodiments, the Surface Docking and the take-off and Landing Platforms can have a landing deck (2410) mounted above the base system with a clear area above and around the landing deck to allow an aerial mobile platform (2412) to land in this area. In at least one embodiment, the landing deck provides interfaces for power and data.

In at least one embodiment, the surface docking platform can include a tether for power, data, and guidance to connect to one or more surface, submersible, or robotic mobile platforms. In at least one embodiment, the surface docking and the take-off and landing platforms can include a crane for lifting one or more surface, submersible, and/or floor robotic mobile platforms out of the water and to deposit into a cradle for transport. In at least one embodiment, the surface docking platform can have a lift gate (2414, 2416) with a cradle to secure a submersible (2418) or floor robotic (2418) mobile platform to lift it out of the water for transport.

In at least one embodiment, the surface docking and the take-off and landing platforms can include mechanical interfaces to refill the central storage compartments with seed, seedballs, seed pucks, seedling cones, drop bags, and other organism delivery structures on the mobile platforms.

### Electronics, Control Systems & Guidance, & Communication Systems

### General

In some embodiments, the mobile platforms and the subsystem payloads can include an internal computer. In some embodiments, communication links can allow these systems to communicate with the guidance and control system components and to activate and operate the delivery mechanisms, sensors, data collection and storage, and all active electronic components of the various systems. In some embodiments, communication modules can include receivers, transmitters, transceivers, etc.

In some embodiments, a sensor can detect the presence and position of the organism delivery structures (seeds, seedballs, seed pucks, seedling cones, deployable mats, or others). In some embodiments, a sensor can communicate with the control system to trigger the release of the organism delivery structure.

In some embodiments the sensors can communicate with the control system to indicate when and where the organism delivery structures have been distributed and to indicate that the subsystem payload requires to be reloaded with delivery mechanisms.

In some embodiments, the electronic control system can monitor local environmental conditions and change the delivery rate and distribution pattern to match the predetermined distribution density required for the specific target environment.

In some embodiments, wired and wireless communications can be utilized across the platform systems. In some embodiments, underwater wireless laser transmission, active acoustic, optical, and radio transmission systems can be utilized with the submersible and floor robotic mobile platforms.

### Central Management System

In some embodiments, a central information management system can use a central server to communicate with one or more client/user devices and via one or more types of networks (wireless, mesh, internet, Local Area networks (LAN)). In some embodiments, client devices, as non-limiting examples, can include computers in any form, hand-held devices (tablets, phones, etc.), and visual interface devices such as VR/AR headsets and glasses.

In some embodiments, an operating system can allow the client/user to modify various settings, as non-limiting examples, such as distribution densities and patterns, flight time, specific areas to be restored, cancellation of current tasks, return to base, transmission and presentation of data, area map with designation of area to be restored, area that has been restored, and the current position of all mobile platforms and docking/landing platforms, status of power supplies on the mobile platforms, amount of organism delivery structures on board and that have been distributed.

### Guidance

In some embodiments, the mobile platforms can utilize a guidance software control system which can include data from a number of sensors and sources.

In at least one embodiment, the guidance component can comprise a plurality of sensors. In at least one embodiment, sensors can include a positioning system adapted for aerial, surface, and underwater use. In some embodiments, the guidance component can use one or more sensors. In at least one embodiment, one or more sensors can include, but are not limited to, visual, thermal-IR, multispectral/Hyper-spectral, gyroscope, depth sensor, speed sensor, compass, magnetic field sensor, microphone, sonar sensor, temperature, salinity, Radar, side-scanning radar, and GPS or other satellite geo-positioning signals individually or in various combinations.

In at least one embodiment, the sensor signals can be transmitted and shared between the mobile platforms to increase the positioning accuracy of the mobile platforms and with any client or user interface device.

In at least one embodiment, the integrated guidance system can include a computing device, memory, at least one processor, and a software control system. In some embodiments, the integrated guidance system may include hardware components mounted on each of the mobile platforms, subsystem payloads, guidance platforms, and mapping platforms. In some embodiments, the integrated guidance system may include instructions for controlling the propulsion component on each of the mobile platforms, guidance platforms, and mapping platforms.

In at least one embodiment, the instructions for controlling propulsion on each of the mobile platforms, guidance platforms, and mapping platforms can include instructions for processing input from sensors to determine a position and course of movement. In some embodiments, the integrated guidance system can perform navigation by assessing position based on input from the sensors on the specific platform and from other platforms, and controlling movement via the propulsion of each of the platforms.

In at least one embodiment, the integrated guidance system can provide a pre-set path to follow for each of the platforms. In some embodiments, the sensors and integrated guidance system can facilitate the movement by receiving and processing sensor data, such as GPS or other geo-positioning data transmitted in a manner suitable for the above water and underwater environment, and applying the processed data to guide the various platforms. In at least one embodiment, a correction method to GPS or other geo-positioning signals such as real-time kinematic (RTK) can be used to increase the accuracy of the positioning of any of the mobile platforms. In some embodiments, the RTK system can be mounted on the surface mobile platform, the surface docking and the take-off and landing platforms, or on a separate buoy within wireless communication range of the various mobile platforms. In some embodiments, the RTK correction signal can be transmitted to the submersible or floor robotic mobile platforms via a tether or via a wireless, subsurface communication signal.

In some embodiments, the integrated guidance system can be configured to be adaptive to real-time data for the various environmental conditions gathered from the sensors previously described, and to initiate distribution of the seeds, seedlings, and other organisms when the conditions are favorable to the organisms.

In at least one embodiment, the guidance system can track the mobile platforms in real time as the organism delivery structures are distributed. In some embodiments, when the mobile platform has distributed the loaded stock of organism delivery structures, the mobile platform can return to be reloaded. In some embodiments, after the mobile platform is reloaded, the guidance system can direct the mobile platform back to the last location to continue with the distribution with multiple transects with reloads until the distribution pattern has been completed.

In some embodiments, the distribution pattern and pathway of any of the mobile platforms can be reconfigured and updated automatically based on the sensor data and algorithm. As an example, in some implementations, the transit path may include multiple planting or distribution locations which may be along a straight line, curved line, grid, or any other pathway as determined by the algorithm. In some embodiment, as an example, the distribution may be interrupted during the transit in order to plant or distribute in more than one area.

In some embodiments, the mobile platforms can include sensors for obstacle avoidance based on the predetermined transit path. In some embodiments, previously determined obstacles can be integrated into the active transit path while sensors will determine new or unexpected obstacles and can redirect the mobile platform to avoid these new or unexpected instances.

In some embodiments, geo-positioning data can be recorded to provide a map of the actual distribution of the organism delivery structures. In some embodiments, RFID chip or another type of electronic identifier data can provide an indication of the actual distribution.

### Control of Subsystem Payloads

In at least one embodiment, the integrated computing system can trigger the release of the seeds, seedballs, seed pucks, seedling cones, seed bags, deployable mats, and other organism delivery structures from the various Subsystem Payloads when the mobile platform has navigated to the target destination. In at least one embodiment, the integrated computing system can determine that the mobile platform has arrived at the target destination, and can initiate the release of the organism delivery structure. In some embodiments, the subsystem payload can then perform a release function to drop and distribute the organism delivery structure.

### Communication Systems

In at least one embodiment, one or more of the mobile platforms, mapping, and/or guidance systems share data. In some embodiments, data sharing can be accomplished by a mesh network of active platforms and systems, tethers, wireless networks, Bluetooth, satellites, local area network, cellular networks, etc.

### Mapping & Data Collection:

### General

In at least one embodiment, some techniques and systems described herein relate to the monitoring of environments, such as water-based ecosystems, to identify routes, methods, and best mobile platform and organism delivery structures for transporting seed, seedlings, and other organisms to a destination area.

In at least one embodiment, at least some techniques and systems described herein relate to the identification of specific locations for planting and restoration in aquatic ecosystems above and below the surface. In some embodiments, data collected may include, but are not limited to visual, thermal-IR, spectral and hyperspectral, topology, vegetative coverage, biodiversity, soil types, water flow rates and direction, temperature, salinity, oxygen content, presence of toxic compounds, carbon content of existing biomass, carbon content of existing soil and sediments. In at least one embodiment, data can be collected to determine seed producing species, where it is located, availability of seed, and readiness for seed collection.

In at least one embodiment, sensors can include visual, thermal-IR, multispectral/Hyper-spectral, gyroscope, depth sensor, speed sensor, compass, magnetic field sensor, microphone, sonar sensor, temperature, salinity, Radar, side-scanning radar, and GPS or other satellite geo-positioning signals individually or in various combinations.

In at least one embodiment, the data can be used to generate a planting and distribution map and which organism delivery structures, subsystems payloads, mobile platforms, species selection, distribution density patterns, and route planning.

In at least one embodiment, the on-board sensors of the mobile platforms can be used to modify and update the route and distribution in real-time. In at least one embodiment, data from the sensors can be integrated in real time with AI and machine learning systems.

In at least one embodiment, at least some techniques and systems described herein relate to the monitoring of aquatic ecosystems. In some embodiments, monitoring of aquatic ecosystems can allow setting a baseline prior to any planting or restoration work, monitoring during any work, and/or monitoring for post-work success. In some embodiments, monitoring of aquatic ecosystems can also allow the establishment of a baseline and measurement of biodiversity, establishment of new growth of planted species, carbon content and sequestration rates of the biomass and soil and sediment carbon content, and/or other types of aquatic environment characteristics. In some embodiments, data collected and third-party data sets can be processed by an algorithm to measure, calculate, and determine, as examples, but not limited to, flora and fauna distribution, vegetative density, areas of disturbance and degraded areas, biodiversity distribution, invasive species identification, quantification and distribution, disease, vegetative biomass, carbon content, and/or nutrient content. In some embodiments, data collected and third-party data sets can be processed by an algorithm to generate, as examples, but not limited to, three-dimensional map of geographical features, planting and restoration and organism distribution plan, and/or navigation pathways and routes.

### Aerial Data Collection and Mapping System

In at least one embodiment, an aerial mobile platform can include one or more sensors to obtain information about the environment. In at least one embodiment, these sensors can include those for visual, thermal-IR, spectral and hyperspectral, topology, vegetative coverage, biodiversity, soil types, water flow rates and direction, temperature, salinity, oxygen content, presence of toxic compounds, carbon content of existing biomass, carbon content of existing soil and sediments, and/or a sensor for another type of aquatic environment characteristic. In at least one embodiment, an RFID chip or another type of electronic identifier can be able to detect and map the location of seedling cones, seedballs, and/or other organism delivery structures outfitted with an RFID chip or another type of electronic identifier.

### Surface Data Collection and Mapping System

In at least one embodiment, a surface mobile platform can include one or more sensors to obtain information about the environment. In at least one embodiment, these sensors can include those for visual, thermal-IR, spectral and hyperspectral, topology, vegetative coverage, biodiversity, soil types, water flow rates and direction, temperature, salinity, oxygen content, presence of toxic compounds, carbon content of existing biomass, carbon content of existing soil and sediments, and/or a sensor for another type of aquatic environment characteristic. In at least one embodiment, an RFID chip or another type of electronic identifier can be able to detect and map the location of seedballs, seed pucks, seedling cones, drop bags, deployable mats, and/or other organism delivery structures outfitted with an RFID chip or another type of electronic identifier.

### Submersible Data Collection and Mapping System

In at least one embodiment, a submersible mobile platform can include one or more sensors to obtain information about the environment. In at least one embodiment, these sensors can include those for visual, thermal-IR, spectral and hyperspectral, topology, vegetative coverage, biodiversity, soil types, water flow rates and direction, temperature, salinity, oxygen content, presence of toxic compounds, carbon content of existing biomass, carbon content of existing soil and sediments, and/or a sensor for another type of aquatic environment characteristic. In at least one embodiment, an RFID or another type of electronic identifier can be able to detect and map the location of seedballs, seed pucks, seedling cones, drop bags, deployable mats, and/or other organism delivery structures outfitted with an RFID chip or another type of electronic identifier.

### Floor Robotic Data Collection and Mapping System

In at least one embodiment, a Floor Robotic mobile platform can include one or more sensors to obtain information about the environment. In at least one embodiment, these sensors can include those for visual, thermal-IR, spectral and hyperspectral, topology, vegetative coverage, biodiversity, soil types, water flow rates and direction, temperature, salinity, oxygen content, presence of toxic compounds, carbon content of existing biomass, carbon content of existing soil and sediments, and/or a sensor for another type of aquatic environment characteristic. In at least one embodiment, an RFID chip or another type of electronic identifier sensor can be able to detect and map the location of seedballs, seed pucks, seedling cones, drop bags, and/or other organism delivery structures outfitted with an RFID chip or another type of electronic identifier.

### Artificial Intelligence (AI) & Data Analytics

In at least one embodiment, AI specific algorithms can be applied to measure and determine the optimal routes, distribution of species by location, biodiversity (existing and recommended), topology, planting restrictions, and or other types of information related to the aquatic environment. In at least one embodiment, the AI & Data Analytics system can integrate data from the various platforms and sensors with a machine-learning model trained to identify species for biodiversity analysis and/or invasive species.

In at least one embodiment, a computerized method can include input data from one or more sensors on one or more mobile platforms as described. In some embodiments, this data is used to generate one or more maps to determine a route to the target destination, obstacles, the distribution density of the organism delivery structures, species selection guidance, organism delivery structure selection, mobile platform selection.

In at least one embodiment, the data collected can be able to be visualized graphically on an electronic device such as personal computers, cell phones, handheld messaging devices, laptop computers, tablet computers, set-top boxes, personal data assistants, embedded computer systems, electronic book readers, etc.

In at least one embodiment, the AI system can process the collected data to produce an estimate of the biodiversity and make recommendations on additional species that will need to be added, where to add them, and in what density and distribution.

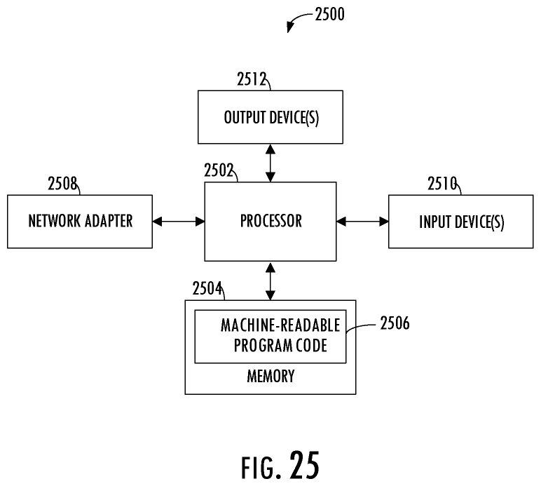

FIG. 25 illustrates the control circuitry (2500) according to some example embodiments of the present disclosure. In some examples, the control circuitry (2500) can be used to control some or all of the functions of the mobile platform. In some examples, the control circuitry may include one or more of each of a number of components such as, for example, a processor (2502) connected to a memory (2504). The processor is generally any piece of computer hardware capable of processing information such as, for example, data, computer programs and/or other suitable electronic information. The processor includes one or more electronic circuits some of which may be packaged as an integrated circuit or multiple interconnected integrated circuits (an integrated circuit at times more commonly referred to as a “chip”). The processor (2502) may be a number of processors, a multi-core processor or some other type of processor, depending on the particular embodiment.

The processor (2502) may be configured to execute computer programs such as machine-readable program code (2506), which may be stored onboard the processor or otherwise stored in the memory (2504). In some examples, the processor may be embodied as or otherwise include one or more ASICs, FPGAs or the like. Thus, although the processor may be capable of executing a computer program to perform one or more functions, the processor of various examples may be capable of performing one or more functions without the aid of a computer program.

The memory (2504) is generally any piece of computer hardware capable of storing information such as, for example, data, computer-readable program code (2506) or other computer programs, and/or other suitable information either on a temporary basis and/or a permanent basis. The memory may include volatile memory such as random-access memory (RAM), and/or non-volatile memory such as a hard drive, flash memory or the like. In various instances, the memory may be referred to as a computer-readable storage medium, which is a non-transitory device capable of storing information. In some examples, then, the computer-readable storage medium is non-transitory and has computer-readable program code stored therein that, in response to execution by the processor (2502), causes the control circuitry (2500) to perform various operations as described herein, some of which may in turn cause the climate control system to perform various operations.

In addition to the memory (2504), the processor (2502) may also be connected to one or more peripherals such as a network adapter (2508), one or more input/output (I/O) devices (2510) or the like. The network adapter is a hardware component configured to connect the control circuitry (2502) to a computer network to enable the control circuitry to transmit and/or receive information via the computer network. The I/O devices may include one or more input devices capable of receiving data or instructions for the control circuitry, and/or one or more output devices capable of providing an output from the control circuitry. Examples of suitable input devices include a keyboard, keypad or the like, and examples of suitable output devices include a display device such as a one or more light-emitting diodes (LEDs), a LED display, a liquid crystal display (LCD), or the like.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device. Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present.

Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for distributing a plurality of organisms in an aquatic ecosystem, the system comprising:
a plurality of organisms incorporated into a plurality of organism delivery structures, wherein each of the plurality of organisms is a non-animal biota;
a mobile platform, configured to be guided by remote control or to autonomously move to distribute the plurality of organisms using the plurality of organism delivery structures in a distribution pattern;
a storage compartment, coupled to the mobile platform, that holds the plurality of organism delivery structures, and
a feeder system, coupled to the storage compartment, that ejects each of the plurality of organism delivery structures according to the distribution pattern, wherein each of the plurality of organisms is distributed at a desired location in the aquatic ecosystem.

2. The system of claim 1, wherein the aquatic ecosystem can include an area that is on, above, or below a water surface.

3. The system of claim 1, each of the plurality of organism delivery structures includes:
one or more of the plurality of organisms;
a degradable structural element;
an additional element such that the organism delivery structure has a density higher than water and a net-negative buoyancy so that the organism delivery structure will sink in an aquatic ecosystem.

4. The system of claim 3, wherein the degradable structural element is one or more of a clay or bioplastic, a compost and/or an activated carbon/biochar, and an anti-predation additive.

5. The system of claim 1, wherein each of the plurality of organisms includes one or more of a seed, seedling, plant. bacteria, fungi, or microbe.

6. The system of claim 1, wherein each of the plurality of organism delivery structure is one of a spherical seedball, a seed-pucks, a conical seedling cone, an open top drop bag, a closed bean-bag-like drop bag, or a deployable mat.

7. The system of claim 1, the mobile platform, comprises:
a form for movement;
a propulsion system for a medium of travel; and
an electronic control system to control the mobile platform;
a processor and memory comprising instructions that, in response to execution the processor, cause the mobile platform to at least:
navigate the mobile platform to a location according to the distribution pattern, and;
cause the storage compartment to distribute one of the plurality of organism delivery structures.

8. The system of claim 7, wherein the processor causes the mobile platform to operate the mobile platform one of individually or as a plurality of the same or mixed types of mobile platforms in a swarm-like configuration.

9. The system of claim 7, wherein the form of movement is one of:
an aerial platform such as a balloon, blimp, drone, or other aircraft;
a water surface craft such as a boat with open or closed bottom, and catamaran;
a submersible watercraft; or
a submersible, floor robotic device.

10. The system of claim 7, wherein the mobile platform further includes a mounted electronically controlled robotic arm on the submersible watercraft and submersible floor robotic device for the placement of organism delivery structures.

11. The system of claim 7, wherein the processor further cause the mobile platform to control a robotic arm for the placement of one of the plurality organism delivery structures to the location.

12. The system of claim 1, further comprising one or more of:
a platform for landing aerial platforms;
a platform for the launch and recovery of submersible and floor robotic platforms; and
an automated system for refilling the organism delivery structures.

13. The system of claim 1, where the system further comprises a power source that can power one or more of the mobile platform, an active subsystem payload component; a docking and landing platform.

14. The system of claim 1, where the system further comprises one or more of:
a sensor mounted to the mobile platforms, surface landing and docking platforms, and stationary buoys for the collection data for local environmental conditions, geographical and topology, ecosystem, biodiversity, biomass carbon, soil carbon, and water flow patterns and rates;
a data communication component; and
a geo-positioning component.

15. The system of claim 14, wherein the geo-positioning component can be one or more of GPS, GNSS, and GLONASS.

16. The system of claim 14, wherein the sensor can collect data on local environmental conditions, geographical and topology, ecosystem, biodiversity, biomass carbon, soil carbon, and water flow patterns and rates.

17. The system of claim 1, wherein the system further includes a server to process collected and third party data to determine one or more of Flora and fauna distribution, Areas of disturbance and degraded ecosystems, Invasive species distribution, Three dimensional map of geographical features, Planting and restoration plan, Navigation routes, and Distribution patterns.
